(19) United States
(12) Patent Application Publication
(10) Pub. No.: US 2015/0185927 A1
(43) Pub. Date: Jul. 2, 2015

(54) INPUT DEVICE AND LIQUID CRYSTAL DISPLAY DEVICE

(71) Applicant: Panasonic Intellectual Property Management Co., Ltd., Osaka (JP)

(72) Inventors: Manabu INOUE, Osaka (JP); Hiroyuki KADO, Osaka (JP); Shigeo KASAHARA, Hyogo (JP); Naoki KOSUGI, Kyoto (JP); Akira TOKAI, Hyogo (JP); Kazushige TAKAGI, Osaka (JP); Takahito NAKAYAMA, Osaka (JP)

(21) Appl. No.: 14/657,884

(22) Filed: Mar. 13, 2015

Related U.S. Application Data
(63) Continuation of application No. PCT/JP2013/006119, filed on Oct. 15, 2013.

(30) Foreign Application Priority Data
Oct. 15, 2012 (JP) 2012-227698

(51) Int. Cl. G06F 3/044; G02F 1/1333

(52) U.S. Cl. CPC G06F 3/044; G02F 1/13338

(57) ABSTRACT

The present invention provides a projected capacitive type input device that easily achieves a high resolution and a large size. The input device is provided in a display device that updates a display by sequentially applying a scanning signal to a plurality of scanning signal lines during one frame period. The input device includes a plurality of driving electrodes and a plurality of detection electrodes that are arranged so as to cross each other. The detection electrodes are arranged parallel to the scanning signal lines. A touch position is detected by applying a driving signal to the driving electrodes and detecting a detection signal output from each of the detection electrodes during a touch detection period.

### TECHNICAL FIELD

The present technology relates to a projected capacitive type input device that can input data by detecting a touch position on a screen, and a liquid crystal display device including the input device and a liquid crystal display panel serving as a display device.

### BACKGROUND ART

A display apparatus including an input device having a screen input function that inputs information through a touch operation by a user's finger on a display screen has been used in mobile electronic equipment such as a PDA and a portable terminal, various household electrical products, and stationary customer guidance terminals such as an unattended reception machine. As the above input device using a touch operation, various systems have been known, such as a resistive film system (Resistive Touch Panel Screen) that detects a change in resistance value of a touched portion, a capacitance coupling system (projected capacitive type Touch Panel Screen) that detects a change in capacitance, and an optical sensor system that detects a change in light amount in a portion shielded by a touch.

Of those various systems, the capacitance coupling system has the following advantages compared with the resistive film system and the optical sensor system. For example, the transmittance of a touch device is as low as about 80% in the resistive film system and the optical sensor system, whereas the transmittance of a capacitance device is as high as about 90%, and the image quality of a display image is not degraded in the capacitance coupling system. Further, the resistive film system has a risk in that a resistive film may be degraded or damaged because a touch position is detected by the mechanical contact of the resistive film, whereas the capacitance coupling system involves no mechanical contact such as contact of a detection electrode with another electrode, and hence also is advantageous from the viewpoint of durability.

As a projected capacitive type input device, e.g., there is given a system as disclosed by Patent document 1.

### PRIOR ART DOCUMENT

### Patent Document

Patent document 1: JP 2011-90458 A

### DISCLOSURE OF INVENTION

### Problem to be Solved by the Invention

It is an object of the present technology to provide a projected capacitive type input device that easily achieves a high resolution and a large size. It is another object of the present technology to provide a liquid crystal display device including a liquid crystal display panel and an input device that easily achieves a high resolution and a large size.

### Means for Solving Problem

In order to solve the above problem, an input device of the present technology is provided in a display device that updates a display by sequentially applying a scanning signal to a plurality of scanning signal lines during one frame period. The input device includes a plurality of driving electrodes and a plurality of detection electrodes that are arranged so as to cross each other, and capacitive elements that are formed between the driving electrodes and the detection electrodes. The detection electrodes are arranged parallel to the scanning signal lines of the display device. A touch position is detected by applying a driving signal to the driving electrodes and detecting a detection signal output from each of the detection electrodes during a touch detection period.

Another input device of the present technology is provided in a display device that includes a plurality of scanning signal lines that are grouped into N line blocks, each line block having M scanning signal lines, and that updates a display by sequentially applying a scanning signal to the scanning signal lines during one frame period. The input device includes a plurality of driving electrodes and a plurality of detection electrodes that are arranged so as to cross each other, and capacitive elements that are formed between the driving electrodes and the detection electrodes. The detection electrodes are arranged parallel to the scanning signal lines of the display device so as to correspond to the respective N line blocks of the scanning signal lines. A touch position is detected by applying a driving signal to the driving electrodes and detecting a detection signal output from each of the detection electrodes during a touch detection period.

A liquid crystal display device of the present technology includes a liquid crystal display panel and an input device. The liquid crystal display panel includes a plurality of pixel electrodes and a common electrode provided so as to be opposed to the pixel electrodes, and updates a display by sequentially applying a scanning signal to switching elements for controlling the application of a voltage to the pixel electrodes. The input device includes a plurality of driving electrodes and a plurality of detection electrodes that are arranged so as to cross each other, and capacitive elements that are formed between the driving electrodes and the detection electrodes. At least one of the plurality of driving electrodes and the plurality of detection electrodes is located inside the liquid crystal display panel. The detection electrodes are arranged parallel to scanning signal lines of the liquid crystal display panel. A touch position is detected by applying a driving signal to the driving electrodes and detecting a detection signal output from each of the detection electrodes during a touch detection period.

### Effects of the Invention

According to the present technology, the projected capacitive type input device includes the detection electrodes that are arranged so as to cross the driving electrodes and to be substantially parallel to the scanning signal lines of the display device. With this configuration, the operation of updating the display of the display device can be performed at the same time as the detection operation of the touch sensor. Thus, the input device easily can achieve a high resolution and a large size. Moreover, the combination of the input device and the liquid crystal display panel (display device) can provide a liquid crystal display device including the liquid crystal display panel that is the most widespread display device and the input device that easily achieves a high resolution and a large size.

### BRIEF DESCRIPTION OF DRAWINGS

FIG. 1 is a block diagram for explaining an entire configuration of a liquid crystal display device having a touch sensor function according to an embodiment.

FIG. 2 is an exploded perspective view showing an example of an arrangement of driving electrodes and detection electrodes constituting a touch sensor.

FIG. 3 is a diagram for explaining a state in which a touch operation is not being performed and a state in which a touch operation is being performed, regarding a schematic configuration and an equivalent circuit of the touch sensor.

FIG. 4 is a diagram for explaining changes in a detection signal when a touch operation is not being performed and when a touch operation is being performed.

FIG. 5 is a schematic diagram showing an arrangement structure of scanning signal lines of a liquid crystal display panel and an arrangement structure of the driving electrodes and the detection electrodes of the touch sensor.

FIG. 6 is a diagram for explaining a configuration of a TFT substrate of the liquid crystal display panel used in the liquid crystal display device having the touch sensor function according to this embodiment.

FIG. 7 is a diagram for explaining a configuration of a counter substrate of the liquid crystal display panel used in the liquid crystal display device having the touch sensor function according to this embodiment.

FIG. 8 is a plan view showing an example of an electrode configuration of one sub-pixel and its periphery in the liquid crystal display panel.

FIG. 9 is a cross-sectional view showing an example of an electrode configuration of one sub-pixel and its periphery in the liquid crystal display panel.

FIG. 10 is a cross-sectional view showing another example of an electrode configuration of one sub-pixel and its periphery in the liquid crystal display panel.

FIG. 11 is a cross-sectional view showing yet another example of an electrode configuration of one sub-pixel and its periphery in the liquid crystal display panel.

FIG. 12 is a diagram for explaining an example of the relationship between (i) the input of a scanning signal to a line block of the scanning signal lines for updating the display of the liquid crystal display panel and (ii) the application of a driving signal to the driving electrodes and the acquisition of a detection signal from each of the detection electrodes for detecting a touch position of the touch sensor.

FIG. 13 is a diagram for explaining an example of the relationship between a detection operation of the detection electrodes and a driving signal applied to the driving electrodes during a scanning period of the scanning signal lines in a line block 10-1.

FIG. 14 is a diagram for explaining another example of the relationship between (i) the input of a scanning signal to a line block of the scanning signal lines for updating the display of the liquid crystal display panel and (ii) the application of a driving signal to the driving electrodes and the acquisition of a detection signal from each of the detection electrodes for detecting a touch position of the touch sensor.

FIG. 15 is a diagram for explaining an example of the relationship between a detection operation of the detection electrodes and a pulse voltage applied to the driving electrodes during a scanning period of the scanning signal lines in each line block.

FIG. 16 is an exploded perspective view showing another example of an arrangement of the driving electrodes and the detection electrodes constituting the touch sensor.

FIG. 17 is a schematic diagram showing an arrangement structure of the scanning signal lines of the liquid crystal display panel and an arrangement structure of the driving electrodes and the detection electrodes of the touch sensor when the touch sensor has another arrangement of the driving electrodes and the detection electrodes.

FIG. 18 is a diagram for explaining a configuration of the TFT substrate of the liquid crystal display panel of the liquid crystal display device having the touch sensor function in another example of the arrangement of the driving electrodes and the detection electrodes.

FIG. 19 is a diagram for explaining a configuration of the counter substrate of the liquid crystal display panel of the liquid crystal display device having the touch sensor function in another example of the arrangement of the driving electrodes and the detection electrodes.

FIG. 20 is a circuit block diagram for explaining a circuit configuration that extracts a touch signal in the liquid crystal display device according to this embodiment.

FIG. 21 is a circuit block diagram for explaining another example of a circuit configuration that extracts a touch signal in the liquid crystal display device according to this embodiment.

FIG. 22 is a diagram showing a first example of the formation of the detection electrodes using a common electrode of the liquid crystal display panel of the liquid crystal display device according to this embodiment.

FIG. 23 is a diagram showing a second example of the formation of the detection electrodes using a common electrode of the liquid crystal display panel of the liquid crystal display device according to this embodiment.

### DESCRIPTION OF THE INVENTION

An input device of the present technology is provided in a display device that updates a display by sequentially applying a scanning signal to a plurality of scanning signal lines during one frame period. The input device includes a plurality of driving electrodes and a plurality of detection electrodes that are arranged so as to cross each other, and capacitive elements that are formed between the driving electrodes and the detection electrodes. The detection electrodes are arranged parallel to the scanning signal lines of the display device. A touch position is detected by applying a driving signal to the driving electrodes and detecting a detection signal output from each of the detection electrodes during a touch detection period.

The input device of the present technology includes the detection electrodes that are arranged so as to cross the driving electrodes and to be parallel to the scanning signal lines of the display device that updates the display by sequentially applying a scanning signal to the scanning signal lines during one frame period. The input device detects a touch position by applying a driving signal to the driving electrodes and detecting a detection signal output from each of the detection electrodes during a touch detection period. With this configuration, the operation of updating the display of the display device can be performed at the same time as the detection operation of the touch sensor. Thus, the input device easily can achieve a high resolution and a large size.

In the input device of the present technology, it is preferable that, during the touch detection period, a detection operation is not performed in the detection electrode in close proximity to the scanning signal line to which the scanning signal is being applied, and a detection operation is performed in the detection electrodes in close proximity to the scanning signal lines to which the scanning signal is not being applied. This configuration effectively can avoid the influence of noise due to the application of the scanning signal. Thus, the input device can detect a touch position with higher accuracy.

Another input device of the present technology is provided in a display device that includes a plurality of scanning signal lines that are grouped into N line blocks, each line block having M scanning signal lines, and that updates a display by sequentially applying a scanning signal to the scanning signal lines during one frame period. The input device includes a plurality of driving electrodes and a plurality of detection electrodes that are arranged so as to cross each other, and capacitive elements that are formed between the driving electrodes and the detection electrodes. The detection electrodes are arranged parallel to the scanning signal lines of the display device so as to correspond to the respective N line blocks of the scanning signal lines. A touch position is detected by applying a driving signal to the driving electrodes and detecting a detection signal output from each of the detection electrodes during a touch detection period.

Another input device of the present technology is provided in the display device including N line blocks, each of which has M scanning signal lines. Moreover, the detection electrodes are arranged so as to correspond to the respective N line blocks. Therefore, in the display device including a plurality of line blocks of the scanning signal lines, the operation of updating the display of the display device can be performed at the same time as the detection operation of the touch sensor. Thus, the input device easily can achieve a high resolution and a large size.

In another input device of the present technology, it is preferable that, during the touch detection period, a detection operation is not performed in the detection electrode in close proximity to the scanning signal line to which the scanning signal is being applied, and a detection operation is performed in the detection electrodes in close proximity to the scanning signal lines to which the scanning signal is not being applied. This configuration effectively can avoid the influence of noise due to the application of the scanning signal. Thus, the input device can detect a touch position with higher accuracy.

It is preferable that at least one of the plurality of detection electrodes and the plurality of driving electrodes is located inside the display device so as to be parallel to the scanning signal lines or to cross the scanning signal lines. With this configuration, the display device including the input device can have a thinner and simpler structure.

A liquid crystal display device of the present technology includes a liquid crystal display panel and an input device. The liquid crystal display panel includes a plurality of pixel electrodes and a common electrode provided so as to be opposed to the pixel electrodes, and updates a display by sequentially applying a scanning signal to switching elements for controlling the application of a voltage to the pixel electrodes. The input device includes a plurality of driving electrodes and a plurality of detection electrodes that are arranged so as to cross each other, and capacitive elements that are formed between the driving electrodes and the detection electrodes. At least one of the plurality of driving electrodes and the plurality of detection electrodes is located inside the liquid crystal display panel. The detection electrodes are arranged parallel to scanning signal lines of the liquid crystal display panel. A touch position is detected by applying a driving signal to the driving electrodes and detecting a detection signal output from each of the detection electrodes during a touch detection period.

The liquid crystal display device of the present technology includes the detection electrodes that are arranged so as to cross the driving electrodes and to be parallel to the scanning signal lines of the liquid crystal display panel that updates the display by sequentially applying a scanning signal to the scanning signal lines during one frame period. The liquid crystal display device detects a touch position by applying a driving signal to the driving electrodes and detecting a detection signal output from each of the detection electrodes during the touch detection period. With this configuration, the operation of updating the display of the liquid crystal display panel can be performed at the same time as the detection operation of the touch sensor. Thus, the liquid crystal display device easily can achieve a high resolution and a large size.

In the liquid crystal display device of the present technology, it is preferable that, during the touch detection period, a detection operation is not performed in the detection electrode in close proximity to the scanning signal line to which the scanning signal is being applied, and a detection operation is performed in the detection electrodes in close proximity to the scanning signal lines to which the scanning signal is not being applied. This configuration effectively can avoid the influence of noise due to the application of the scanning signal in the liquid crystal display panel. Thus, the liquid crystal display device including the input device that can detect a touch position with higher accuracy can be achieved.

### Embodiment

Hereinafter, a touch sensor provided in a liquid crystal display device, together with a liquid crystal display panel (display device), will be described as an example of an input device according to an embodiment of the present technology. This embodiment also is an embodiment of the liquid crystal display device of the present technology. This embodiment merely exemplifies the input device of the present technology, and the input device of the present technology also can be applied to display devices such as organic/inorganic EL (electroluminescent) display devices other than the liquid crystal display device.

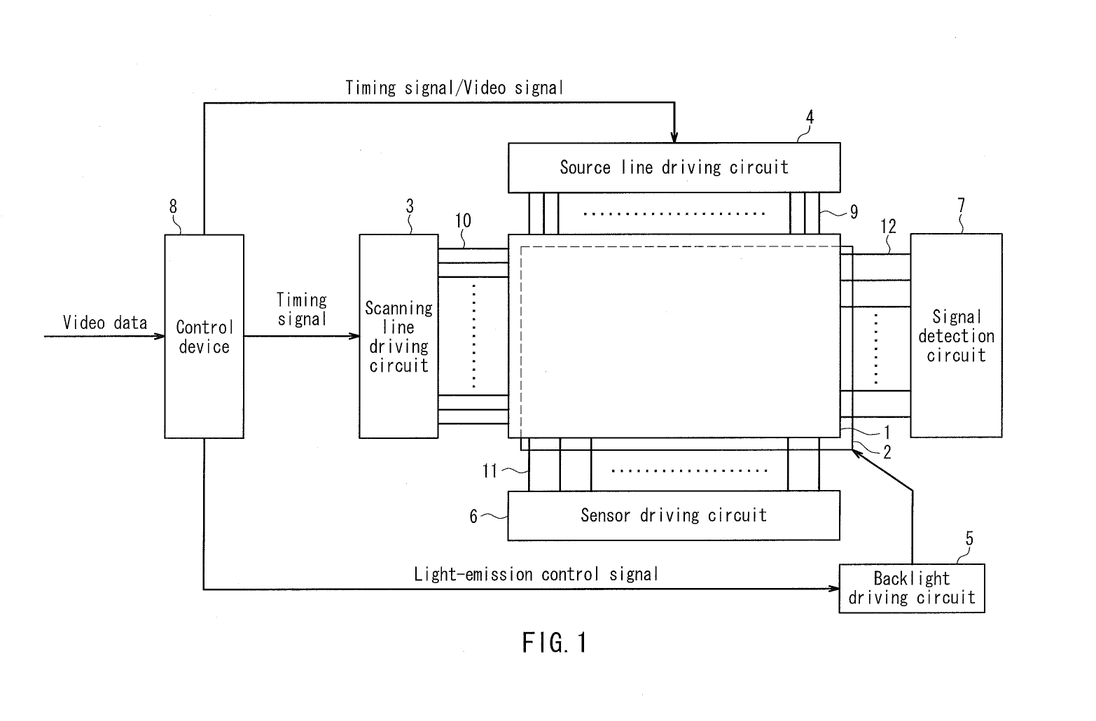

FIG. 1 is a block diagram for explaining an entire configuration of a liquid crystal display device having a touch sensor function (input device) according to an embodiment of the present technology.

As shown in FIG. 1, the liquid crystal display device includes a liquid crystal display panel 1, a backlight unit 2, a scanning line driving circuit 3, a source line driving circuit 4, a backlight driving circuit 5, a sensor driving circuit 6, a signal detection circuit 7, and a control device 8.

The liquid crystal display panel 1 has a rectangular plate shape, and includes a TFT substrate formed of a transparent substrate such as a glass substrate, and a counter substrate located opposite the TFT substrate with a predetermined space between them. A liquid crystal material is sealed between the TFT substrate and the counter substrate.

The TFT substrate is located on a back surface side of the liquid crystal display panel 1, and pixel electrodes, thin film transistors (TFTs), a common electrode, and the like are formed on the transparent substrate made of glass (base material). The pixel electrodes are arranged in a matrix. The TFTs are provided so as to correspond to the respective pixel electrodes, and serve as switching elements for turning on/off the application of a voltage to the corresponding pixel electrodes.

The counter substrate is located on a front surface side of the liquid crystal display panel 1, and color filters (CF) of three primary colors of red (R), green (G), and blue (B) are formed on the transparent substrate made of glass (base material). The RGB color filters constitute sub-pixels, respectively, and are arranged at positions corresponding to the respective pixel electrodes provided on the TFT substrate. Moreover, a black matrix made of a light-shielding material for enhancing contrast is formed on the counter substrate and arranged between the RGB sub-pixels and/or between the pixels, each of which is composed of the sub-pixels. In this embodiment, an n-channel type TFT including a drain electrode and a source electrode is used as the TFT corresponding to each of the pixel electrodes provided on the TFT substrate.

On the TFT substrate, a plurality of video signal lines 9 and a plurality of scanning signal lines 10 are formed so as to cross substantially at right angles. The scanning signal lines 10 are provided for each horizontal row of the TFTs, and each of the scanning signal lines 10 is commonly connected to gate electrodes of the TFTs in the horizontal row. The video signal lines 9 are provided for each vertical column of the TFTs, and each of the video signal lines 9 is commonly connected to drain electrodes of the TFTs in the vertical column. Moreover, the pixel electrodes arranged in an image display area are connected to source electrodes of the corresponding TFTs.

Each of the TFTs formed on the TFT substrate is turned on/off with a unit of a horizontal row in accordance with a scanning signal to be applied to the scanning signal line 10. Each of the TFTs in a horizontal row, which has been turned on, sets the electric potential of a pixel electrode that is connected to the TFT to an electric potential (pixel voltage) in accordance with a video signal to be applied to the video signal line 9. The liquid crystal display panel 1 includes a plurality of the pixel electrodes and a common electrode provided so as to be opposed to the pixel electrodes. In the liquid crystal display panel 1, the alignment of a liquid crystal is controlled for each area, where the pixel electrode is formed, by an electric field generated between the pixel electrode and the common electrode so that the transmittance with respect to light entering the liquid crystal display panel 1 from the backlight unit 2 is changed, thereby producing an image on a display screen.

The backlight unit 2 is disposed on the back surface side of the liquid crystal display panel 1 and irradiates the liquid crystal display panel 1 with light from the back surface thereof. As the backlight unit 2, for example, the following are known: a backlight unit having a structure in which a plurality of light-emitting diodes are arranged to form a surface light source; and a backlight unit having a structure in which a light-guiding plate and a diffuse reflector are used in combination, and light from light-emitting diodes is used as a surface light source.

The scanning line driving circuit 3 is connected to a plurality of the scanning signal lines 10 formed on the TFT substrate.

The scanning line driving circuit 3 sequentially selects the scanning signal lines 10 in response to a timing signal input from the control device 8 and applies a voltage for turning on the TFTs of the selected scanning signal line 10. For example, the scanning line driving circuit 3 includes a shift register. The shift register starts its operation in response to a trigger signal from the control device 8, and the operation involves sequentially selecting the scanning signal lines 10 in the order along a vertical scanning direction and outputting a scanning pulse (scanning signal) to the selected scanning signal line 10.

The source line driving circuit 4 is connected to a plurality of the video signal lines 9 formed on the TFT substrate.

The source line driving circuit 4 applies a voltage, which corresponds to a video signal indicating a gray-scale value of each sub-pixel, to the TFTs connected to the selected scanning signal line 10, in accordance with the selection of the scanning signal line 10 by the scanning line driving circuit 3. As a result, a video signal is written in the pixel electrodes arranged in the sub-pixels corresponding to the selected scanning signal line 10.

The backlight driving circuit 5 causes the backlight unit 2 to emit light at a timing and brightness in accordance with a light-emission control signal input from the control device 8.

A plurality of driving electrodes 11 and a plurality of detection electrodes 12 are arranged so as to cross each other as electrodes forming a touch sensor (input device) on the liquid crystal display panel 1.

The touch sensor formed of the driving electrodes 11 and the detection electrodes 12 detects input of an electric signal and response to the electric signal due to a change in capacitance between the driving electrodes 11 and the detection electrodes 12, and detects contact of an object on a display surface. As an electric circuit for detecting the contact, a sensor driving circuit 6 and a signal detection circuit 7 are provided.

The sensor driving circuit 6 is an AC signal source and is connected to the driving electrodes 11. For example, the sensor driving circuit 6 receives a timing signal from the control device 8, sequentially selects the driving electrodes 11, and applies a driving signal Txv based on a rectangular pulse voltage to the selected driving electrode 11.

Note that the driving electrodes 11 and the video signal lines 9 are formed on the TFT substrate so as to extend in the vertical direction and are arranged in a plural number in the horizontal direction. The sensor driving circuit 6 and the source line driving circuit 4 are connected electrically to the driving electrodes 11 and the video signal lines 9, respectively, and can be located along a horizontal side of the image display area where the pixels are arranged. In the liquid crystal display device of this embodiment, the source line driving circuit 4 is disposed on one of the upper and lower sides, and the sensor driving circuit 6 is disposed on the other side.

The signal detection circuit 7 is a detection circuit for detecting a change in capacitance and is connected to the detection electrodes 12. The signal detection circuit 7 is provided with a detection circuit for each detection electrode 12 and detects a voltage of the detection electrode 12 as a detection signal Rxv. Note that another configuration example of the signal detection circuit may be as follows: one signal detection circuit is provided for a group of a plurality of detection electrodes 12, and the voltage of the detection signal Rxv of the plurality of detection electrodes 12 is monitored in a time-division manner during the duration time of a pulse voltage applied to the driving electrodes 11 to detect the detection signal Rxv from each of the detection electrodes 12.

A contact position of an object on a display surface, that is, a touch position, is determined based on which detection electrode 12 detects a detection signal Rxv at a time of contact when the driving signal Txv is applied to which driving electrode 11, and an intersection between the driving electrode 11 and the detection electrode 12 is determined as a contact position by arithmetic calculation. Note that, as a calculation method for determining a contact position, there may be given a method using an arithmetic processing circuit provided in a liquid crystal display device and a method using an arithmetic processing circuit provided outside of the liquid crystal display device.

The control device 8 includes an arithmetic processing circuit such as a CPU and memories such as a ROM and a RAM. The control device 8 performs various image signal processing such as color adjustment to generate an image signal indicating a gray-scale value of each sub-pixel based on input video data, and applies the image signal to the source line driving circuit 4. Further, the control device 8 generates a timing signal for synchronizing the operations of the scanning line driving circuit 3, the source line driving circuit 4, the backlight driving circuit 5, the sensor driving circuit 6, and the signal detection circuit 7 based on the input video data and applies the timing signal to those circuits. Further, the control device 8 applies a brightness signal for controlling the brightness of a light-emitting diode based on the input video data as a light-emission control signal to the backlight driving circuit 5.

In the liquid crystal display device of this embodiment, the scanning line driving circuit 3, the source line driving circuit 4, the sensor driving circuit 6, and the signal detection circuit 7 that are connected to the respective signal lines and electrodes of the liquid crystal display panel 1 are configured by mounting semiconductor chips of these circuits on a flexible wiring board, a printed wiring board, and a glass substrate. However, the scanning line driving circuit 3, the source line driving circuit 4, and the sensor driving circuit 6 may be mounted on the TFT substrate by simultaneously forming predetermined electronic circuits such as semiconductor circuit elements along with TFTs or the like.

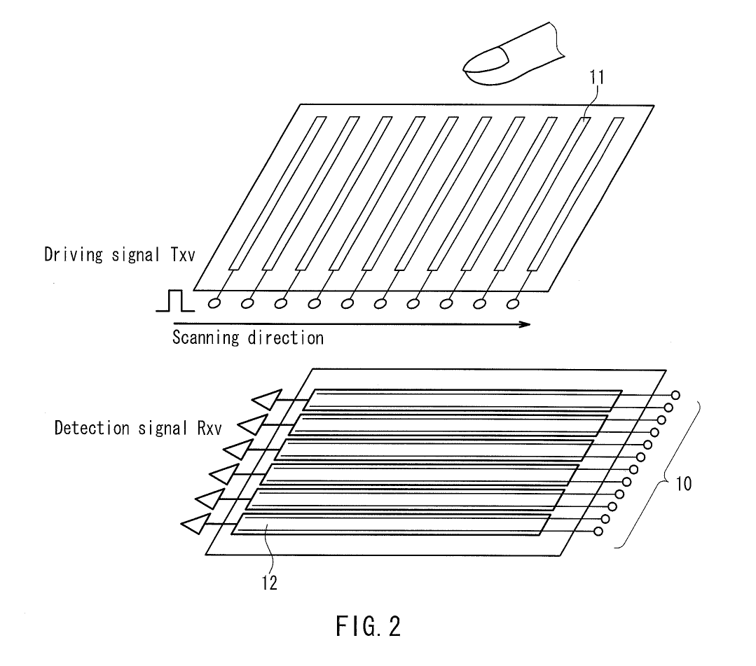

FIG. 2 is a perspective view showing an example of the arrangement of the driving electrodes and the detection electrodes constituting the touch sensor.

As shown in FIG. 2, the touch sensor (input device) includes the detection electrodes 12 as a stripe-shaped electrode pattern of a plurality of electrodes extending in the horizontal direction of FIG. 2 and the driving electrodes 11 as a stripe-shaped electrode pattern of a plurality of electrodes extending in a direction crossing the extending direction of the electrode pattern of the detection electrodes 12. A capacitive element having capacitance is formed at each of the crossed portions of the driving electrodes 11 and the detection electrodes 12. In the liquid crystal display device of this embodiment, the detection electrodes 12 can be formed by using the pixel electrodes that are used for image display on the liquid crystal display panel 1 or by arranging predetermined electrodes in the liquid crystal display panel 1.

The detection electrodes 12 are arranged parallel to the direction in which the scanning signal lines 10 extend. In this specification, when the detection electrodes and the scanning signal lines are arranged in parallel, the detection electrodes and the scanning signal lines are arranged so as to extend in the same direction. This does not mean that the detection electrodes and the scanning signal lines are perfectly parallel in a strict geometric sense.

As will be described in detail later, the scanning signal lines are grouped into N (N is a natural number) line blocks, and each line block has M (M is a natural number) scanning signal lines. The detection electrodes are arranged so as to correspond to the respective N line blocks and to allow a detection signal to be detected for each line block.

In performing a detection operation of a touch position, the sensor driving circuit 6 sequentially applies a driving signal Txv to each of the driving electrodes 11 arranged in the row direction (vertical direction). For example, the driving signal Txv is applied in a scanning direction (from the left to the right) shown in FIG. 2. Moreover, a detection signal Rxv is detected from the detection electrode 12 that corresponds to a line block to be detected. Thus, a touch position corresponding to the line block is detected.

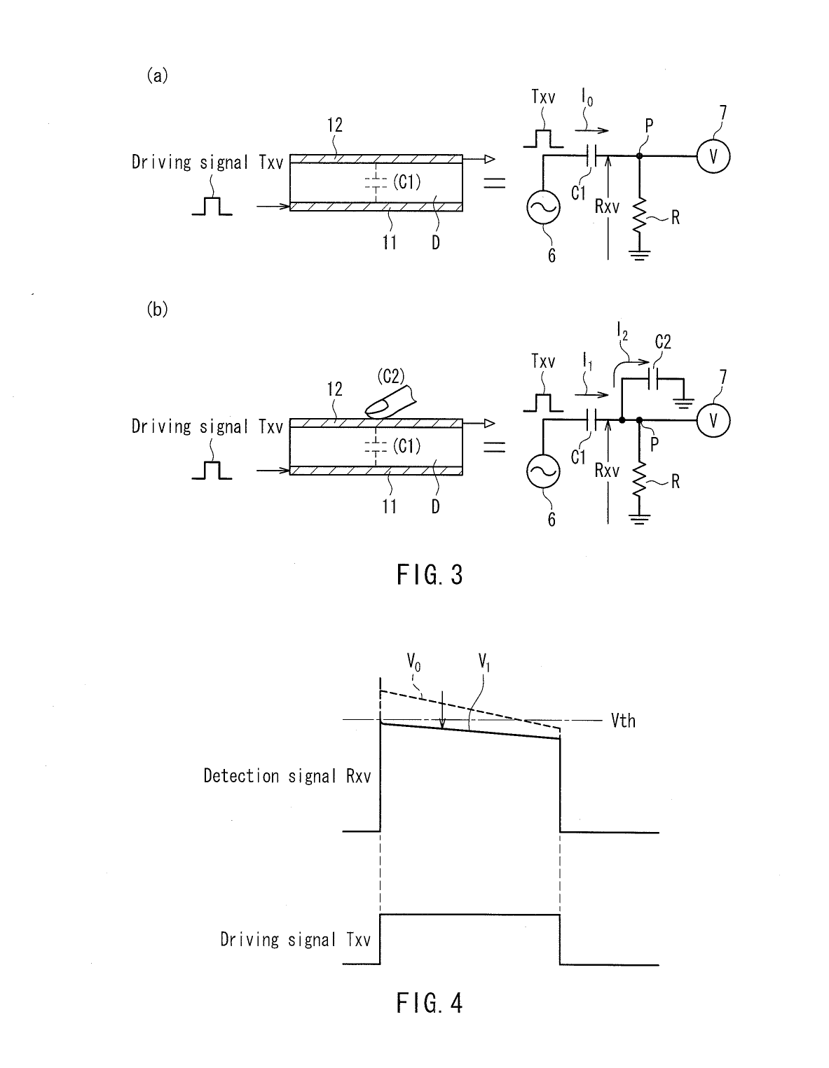

Next, a principle of detecting a touch position (voltage detection type) of a capacitive Touch Panel Screen will be described with reference to FIGS. 3 and 4.

FIGS. 3(a) and 3(b) are diagrams for explaining a state in which a touch operation is not being performed (FIG. 3(a)) and a state in which a touch operation is being performed (FIG. 3(b)), regarding a schematic configuration and an equivalent circuit of the touch sensor. FIG. 4 is a diagram for explaining changes in a detection signal when a touch operation is not being performed and when a touch operation is being performed, as shown in FIG. 3.

As shown in FIG. 2, in the capacitive Touch Panel Screen, the crossed portions between each pair of the driving electrodes 11 and the detection electrodes 12, which are arranged in a matrix so as to cross each other, form capacitive elements. In each of the capacitive elements, the driving electrode 11 and the detection electrode 12 are opposed to each other with a dielectric D interposed between them, as shown in FIG. 3(a). The equivalent circuit is expressed as shown on the right side of FIG. 3(a), and the driving electrode 11, the detection electrode 12, and the dielectric D form a capacitive element C1. One end of the capacitive element C1 is connected to the sensor driving circuit 6 serving as an AC signal source, and the other end P of the capacitive element C1 is grounded through a resistor R and connected to the signal detection circuit 7 serving as a voltage detector.

When the driving signal Txv (FIG. 4) based on a pulse voltage with a predetermined frequency of about tens to hundreds of kHz is applied to the driving electrode 11 (i.e., one end of the capacitive element C1) from the sensor driving circuit 6 serving as an AC signal source, an output waveform (detection signal Rxv) as shown in FIG. 4 appears in the detection electrode 12 (i.e., the other end P of the capacitive element C1).

When a finger is not in contact with (or is not close to) a display screen, a current I₀ in accordance with a capacitive value of the capacitive element C1 flows along with charge and discharge with respect to the capacitive element C1, as shown in FIG. 3(a). As a potential waveform of the other end P of the capacitive element C1 in this case, a waveform V₀ of FIG. 4 is obtained, and the waveform V₀ is detected by the signal detection circuit 7 serving as a voltage detector.

On the other hand, when a finger is in contact with (or is close to) the display screen, the equivalent circuit takes a form in which a capacitive element C2 formed by the finger is added in series to the capacitive element C1 as shown in FIG. 3(b). In this state, currents I₁ and I₂ flow along with the charge and discharge with respect to the capacitive elements C1 and C2, respectively. As the potential waveform of the other end P of the capacitive element C1 in this case, a waveform V₁ of FIG. 4 is obtained, and the waveform V₁ is detected by the signal detection circuit 7 serving as a voltage detector. At this time, the potential at the point P becomes a partial voltage potential determined by the values of the currents I₁ and I₂ flowing through the capacitive elements C1 and C2, respectively. Therefore, the waveform V₁ becomes a value smaller than that of the waveform V₀ in a non-contact state.

The signal detection circuit 7 compares the potential of the detection signal output from each of the detection electrodes 12 with a predetermined threshold voltage Vₜₕ. If the potential is equal to or more than the threshold voltage, the signal detection circuit 7 determines that the state is a non-contact state. If the potential is less than the threshold voltage, the signal detection circuit 7 determines that the state is a contact state. Consequently, a touch position can be detected. In order to detect a touch position, a change in capacitance also may be detected, e.g., by a method for detecting a current, in addition to the method for determining the magnitude of the voltage as shown in FIG. 4.

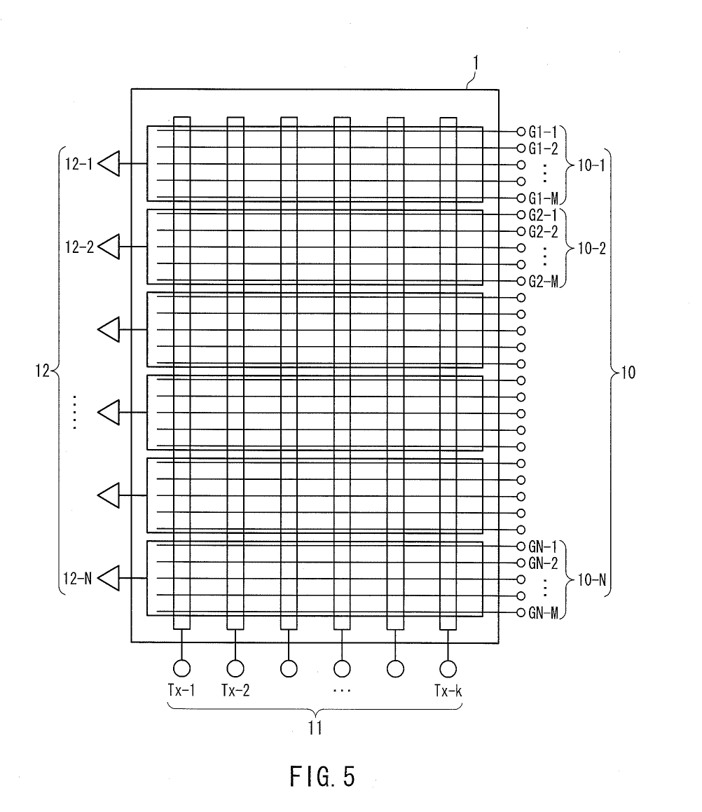

FIG. 5 is a schematic diagram showing an arrangement structure of the scanning signal lines of the liquid crystal display panel and an arrangement structure of the driving electrodes and the detection electrodes of the touch sensor.

As shown in FIG. 5, the scanning signal lines 10 extending in the horizontal direction are divided into a plurality of N (N is a natural number) line blocks 10-1, 10-2, . . . , 10-N, and each line block has M (M is a natural number) scanning signal lines G1-1, G1-2, . . . , G1-M.

The detection electrodes 12 of the touch sensor are arranged so that N detection electrodes 12-1, 12-2, . . . , 12-N extending in the horizontal direction correspond to the line blocks 10-1, 10-2, . . . , 10-N, respectively. Then, a plurality of driving electrodes 11 (Tx-1, Tx-2, . . . , Tx-k) are arranged so as to cross the N detection electrodes 12-1, 12-2, . . . , 12-N.

The liquid crystal display panel (display device) 1 includes a plurality of scanning signal lines 10 that are grouped into N line blocks, and each line block has M scanning signal lines. The liquid crystal display panel 1 is configured to update the display by sequentially applying a scanning signal to the scanning signal lines 10 during one frame period. The detection electrodes 12 of the touch sensor (input device) are arranged parallel to the scanning signal lines 10 so that the detection electrodes 12-1, 12-2, . . . , 12-N correspond to the N line blocks 10-1, 10-2, . . . , 10-N, respectively. The driving electrodes 11 are arranged so as to cross substantially at right angles to the detection electrodes 12-1, 12-2, . . . , 12-N with an insulating layer interposed between them. The capacitive element C1 shown in FIG. 3 is substantially formed at each of the crossed portions between the driving electrodes and the detection electrodes. The touch sensor is configured to detect a touch position by sequentially applying a driving signal to the driving electrodes 11 and detecting a detection signal output from each of the detection electrodes 12-1, 12-2, . . . , 12-N during a touch detection period.

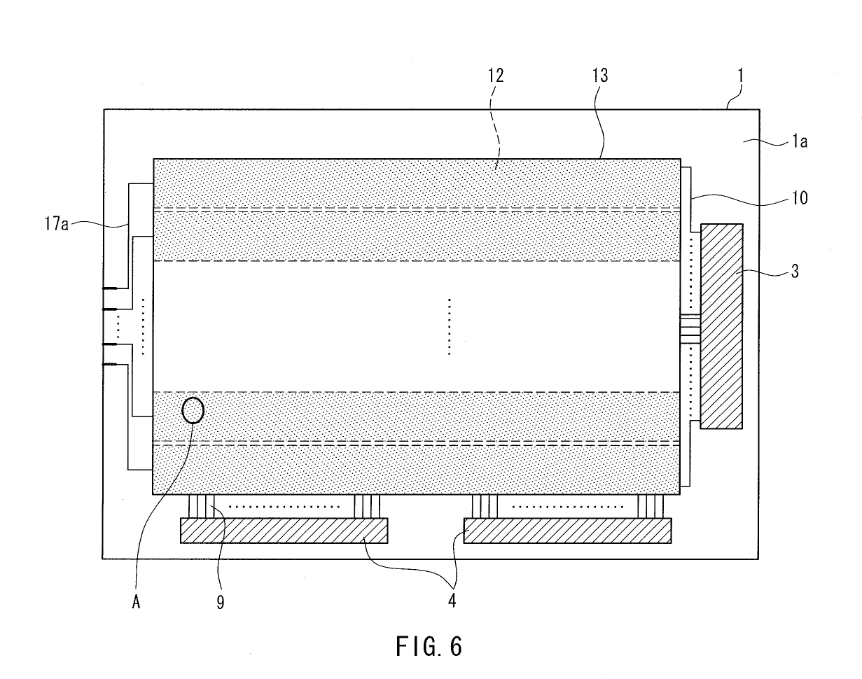

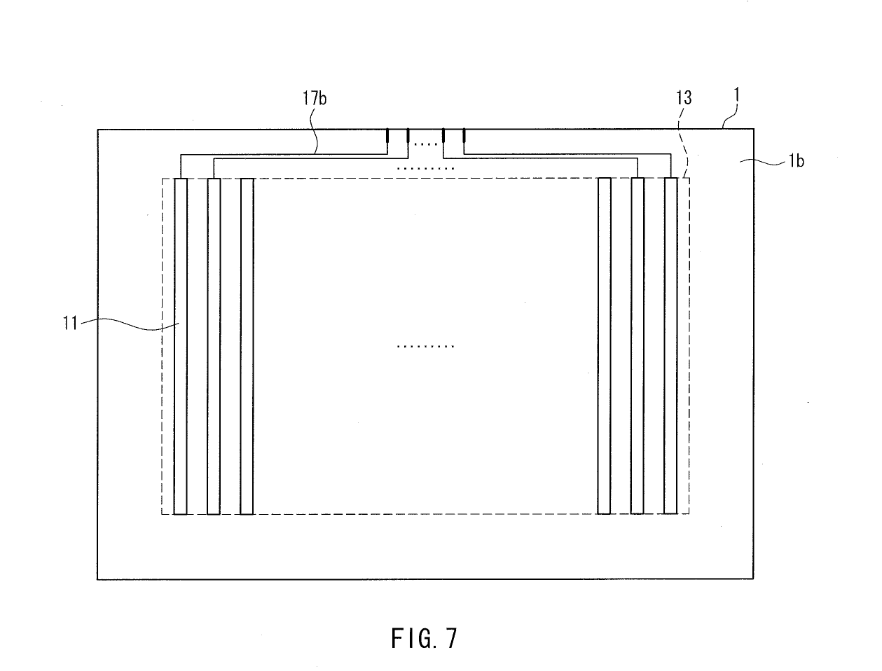

FIGS. 6 and 7 are diagrams for explaining a configuration of the liquid crystal display panel of the liquid crystal display device having the touch sensor function according to an embodiment of the present technology. FIG. 6 is a schematic plan view showing a configuration of the TFT substrate of the liquid crystal display panel. FIG. 7 is a schematic plan view showing a configuration of the counter substrate located opposite the TFT substrate. FIGS. 6 and 7 illustrate the respective substrates when viewed from the front surface side of the liquid crystal display panel 1, i.e., from the direction in which a viewer sees the displayed image.

As shown in FIG. 6, the pixel electrodes, the thin film transistors (TFTs), the common electrode, and the like are formed on the TFT substrate 1a of the liquid crystal display panel 1. The pixel electrodes are arranged in a matrix and correspond to the sub-pixels, respectively. The TFTs are provided so as to correspond to the respective pixel electrodes, and serve as switching elements for turning on/off the application of a voltage to the corresponding pixel electrodes. The common electrode is provided so as to be opposed to the pixel electrodes via an insulating layer. With this configuration, an image display area 13 is formed, in which an image is displayed on the liquid crystal display panel 1. For the sake of brevity, FIG. 6 only shows the image display area 13 and omits the pixel electrodes, the TFTs, and the common electrode.

Moreover, the source line driving circuit 4 connected to the video signal lines 9 and the scanning line driving circuit 3 connected to the scanning signal lines 10 are formed on the TFT substrate 1a. As described with reference to FIG. 1, the video signal lines 9 and the scanning signal lines 10 are arranged so as to cross substantially at right angles on the TFT substrate 1a. The scanning signal lines 10 are provided in the horizontal direction of the TFTs corresponding to the respective pixel electrodes, and are commonly connected to the gate electrodes of the TFTs. The video signal lines 9 are provided in the vertical direction of the TFTs corresponding to the respective pixel electrodes, and are commonly connected to the drain electrodes of the TFTs. The pixel electrodes arranged in the image display area are connected to the source electrodes of the corresponding TFTs.

As shown in FIG. 7, the counter substrate 1b is located on the front surface side of the liquid crystal display panel 1. The counter substrate 1b is made of a transparent glass substrate, and the color filters of three primary colors and the black matrix are formed on the surface of the transparent glass substrate that faces the TFT substrate 1a. The color filters of three primary colors constitute red (R), green (G), and blue (B) sub-pixels, respectively, and are arranged at positions corresponding to the respective pixel electrodes provided on the TFT substrate 1a. The black matrix serves as a light-shielding portion made of a light-shielding material for enhancing contrast between the RGB sub-pixels. For the sake of brevity, FIG. 7 omits the color filters and the black matrix, and shows the area where these components are to be placed as the image display area 13.

In the liquid crystal display panel 1 of the liquid crystal display device of this embodiment, the detection electrodes 12 are arranged on the TFT substrate 1a side. The stripe-shaped driving electrodes 11 are arranged on the counter substrate 1b so as to cross the detection electrodes 12 provided on the TFT substrate 1a. Specifically, the common electrode is provided on the TFT substrate 1a so as to be opposed to the pixel electrodes via the insulating layer in the image display area 13. As shown in FIG. 6, the common electrode is cut along cutting plane lines extending in the horizontal direction, so that a plurality of detection electrodes 12 extending in the row direction (horizontal direction) of the pixel array are formed. On the other hand, as shown in FIG. 7, a known transparent conductive material such as indium tin oxide (ITO) or indium zinc oxide (IZO) is patterned on the front surface of the counter substrate 1b (on the viewer side), which is on the other side of the surface provided with the color filter layer or the like, so that a plurality of driving electrodes 11 extending in the column direction (vertical direction) of the pixel array are formed.

As shown in FIGS. 6 and 7, the liquid crystal display panel 1 of this embodiment includes terminal extraction portions 17a, 17b that electrically connect the detection electrodes 12 and the driving electrodes 11 to the signal detection circuit 7 and the sensor driving circuit 6 (not shown in FIGS. 6 and 7) via a flexible wiring board (FPC) or the like, respectively. The terminal extraction portions 17a, 17b are formed into so-called solid patterns with a large width in order to reduce the resistance value and improve the detection accuracy and the detection speed. The terminal extraction portions 17a, 17b are preferably made of a low-resistance metal material (aluminum, copper, etc.).

In FIG. 6, the scanning line driving circuit 3 is located on the right side of the image display area 13 on the TFT substrate 1a, and the source line driving circuit 4 is located on the lower side of the image display area 13 on the TFT substrate 1a. However, the locations of the scanning line driving circuit 3 and the source line driving circuit 4 are not limited thereto. When the scanning line driving circuit 3 and the source line driving circuit 4 are arranged on the TFT substrate 1a, they may be located in any place around the image display area 13. In many cases, based on the extending directions of the video signal lines 9 and the scanning signal lines 10, the scanning line driving circuit 3 is located on either the left side or the right side of the image display area 13, and the source line driving circuit 4 is located on either the upper side or the lower side of the image display area 13. Moreover, the scanning line driving circuit 3 and the source line driving circuit 4 also may be located in places other than the surface of the TFT substrate 1a via the FPC or the like.

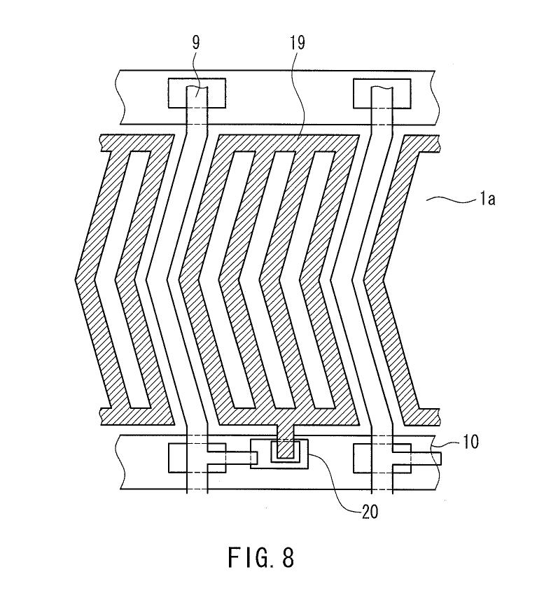

FIG. 8 is a partially enlarged plan view showing an example of an electrode configuration of one sub-pixel and its periphery on the TFT substrate of the liquid crystal display panel in the region represented by A in FIG. 6.

As shown in FIG. 8, in the liquid crystal display panel 1 of this embodiment, a pixel electrode 19, a TFT 20, a scanning signal line 10, and a video signal line 9 are layered on the surface of the TFT substrate 1a that faces the liquid crystal layer (i.e., the front surface side) while an insulating layer is optionally interposed between them. The pixel electrode 19 is made of a transparent conductive material such as indium tin oxide (ITO) or indium zinc oxide (IZO), and connected to a source electrode of the TFT 20. The scanning signal line 10 is connected to a gate electrode of the TFT 20. The video signal line 9 is connected to a drain electrode of the TFT 20.

The TFT 20 includes a semiconductor layer, and an ohmic connection is established between the semiconductor layer and each of the drain electrode and the source electrode. The source electrode is connected to the pixel electrode 19 through a contact hole (not shown). The gate electrode that is connected to the scanning signal line 10 is formed in a lower layer of the semiconductor layer.

As an example of the liquid crystal display panel used in the liquid crystal display device of this embodiment, FIG. 8 shows a so-called IPS type liquid crystal display panel in which an electric field is applied in a lateral direction with respect to the liquid crystal layer. The pixel electrode 19 has a comb-like shape so that the electric field between the pixel electrode 19 and the common electrode extends to the liquid crystal layer in an effective area that forms one sub-pixel. In the effective area, the pixel electrode 19 is formed, and the liquid crystal layer contributes to image display. The effective area is surrounded by a boundary area where the liquid crystal layer does not contribute to image display. In the boundary area, the scanning signal line 10 and the video signal line 9 are arranged, and the TFT 20 is provided in the vicinity of the intersection between these signal lines.

Although not shown in FIG. 8, the common electrode is formed in a lower layer of the pixel electrode 19 so as to be opposed to the pixel electrode 19 via an interlayer insulating film. That is, the common electrode is located at a position that overlaps the pixel electrode 19 in the thickness direction of the liquid crystal display panel 1. In this case, the common electrode is formed into a substantially planar shape (so-called solid pattern) in at least a portion that overlaps the effective area including the pixel electrode 19. In the liquid crystal display panel 1 of this embodiment shown in FIG. 8, the common electrode is separated by making slits in a direction parallel to the arrangement direction of the scanning signal lines 10. Consequently, the separated common electrodes also are used as a plurality of detection electrodes 12 of the touch sensor that are arranged parallel to the scanning signal lines 10.

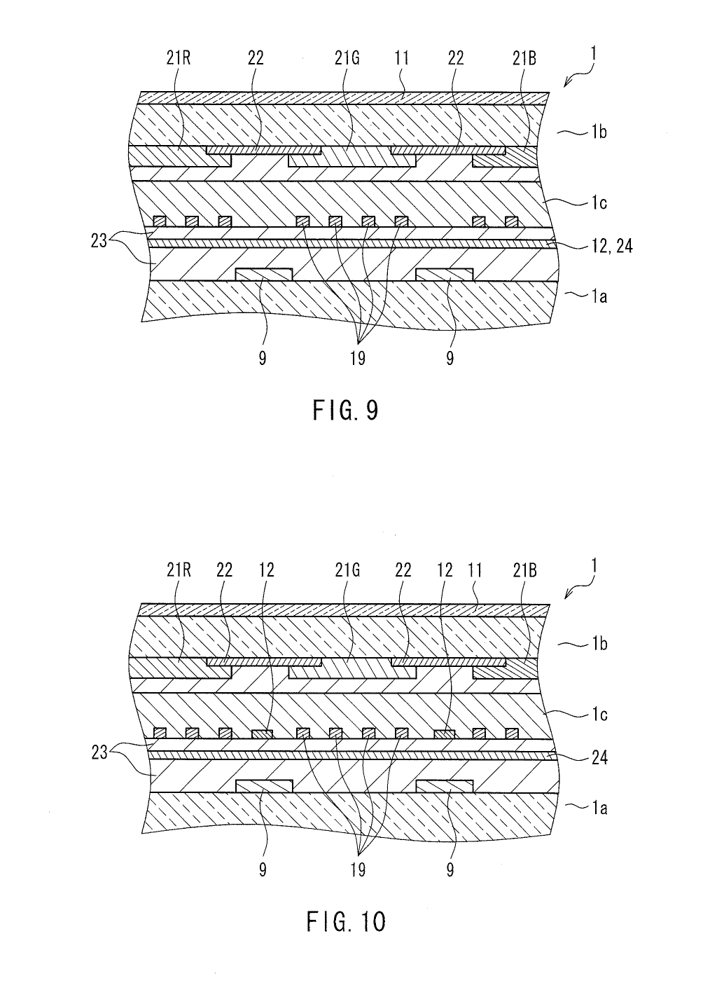

FIG. 9 is a schematic cross-sectional view of the region represented by A in FIG. 6, i.e., the region shown in a plan view of FIG. 8.

As shown in FIG. 9, the liquid crystal display panel 1 includes the TFT substrate 1a formed of a transparent substrate such as a glass substrate, and the counter substrate 1b located opposite the TFT substrate 1a with a predetermined space between them. The liquid crystal material 1c is sealed between the TFT substrate 1a and the counter substrate 1b to form a liquid crystal layer.

The TFT substrate 1a is located on the back surface side of the liquid crystal display panel 1, and the pixel electrodes 19, the TFTs, and the common electrode 24 are formed on the surface of the transparent substrate (main body) of the TFT substrate 1a. The pixel electrodes 19 are arranged in a matrix. The TFTs are provided so as to correspond to the respective pixel electrodes 19, and serve as switching elements for turning on/off the application of a voltage to the corresponding pixel electrodes 19. The common electrode 24 is provided so as to be opposed to the pixel electrodes 19 via an interlayer insulating film 23. As described above, the common electrode 24 of the liquid crystal display panel 1 of this embodiment also is used as the detection electrodes 12 of the touch sensor.

The counter substrate 1b is located on the front surface side of the liquid crystal display panel 1, and the color filters 21R, 21G, and 21B of three primary colors and the black matrix 22 are formed on the surface of the transparent substrate (main body) of the counter substrate 1b that faces the TFT substrate 1a. The color filters 21R, 21G, and 21B constitute red (R), green (G), and blue (B) sub-pixels, respectively, and are arranged at positions overlapping (corresponding to) the respective pixel electrodes 19 provided on the TFT substrate 1a in the thickness direction of the liquid crystal display panel 1. The black matrix 22 serves as a light-shielding portion made of a light-shielding material for enhancing the contrast of an image to be displayed. The black matrix 22 is arranged between the RGB sub-pixels and between the pixels, each of which is composed of the three sub-pixels.

In the liquid crystal display panel 1 of this embodiment, the driving electrodes 11 are formed on the surface of the counter substrate 1b that faces the viewer side. As described above, the driving electrodes 11 are formed into a predetermined shape by patterning the transparent conductive material such as indium tin oxide (ITO) or indium zinc oxide (IZO).

Although not described in detail, like a general active matrix liquid crystal display panel, the interlayer insulating film 23 is formed between the components (such as electrodes and lines) on the TFT substrate 1a, to which a predetermined voltage is applied.

As described above, the video signal lines 9 connected to the drain electrodes of the TFTs 20 and the scanning signal lines 10 connected to the gate electrodes of the TFTs 20 are arranged so as to cross at right angles on the TFT substrate 1a. The scanning signal lines 10 are provided for each horizontal row of the TFTs 20, and each of the scanning signal lines 10 is commonly connected to the gate electrodes of the TFTs 20 in the horizontal row. The video signal lines 9 are provided for each vertical column of the TFTs 20, and each of the video signal lines 9 is commonly connected to the drain electrodes of the TFTs 20 in the vertical column. Moreover, the pixel electrodes 19 are connected to the source electrodes of the corresponding TFTs 20.

FIG. 10 is a cross-sectional view showing a first example in which the detection electrodes of the touch sensor are formed in a different place in the liquid crystal display panel of this embodiment. Like FIG. 9, FIG. 10 illustrates the region represented by A in FIG. 6, i.e., the region shown in a plan view of FIG. 8.

The first example shown in FIG. 10 differs from the configuration shown in FIG. 9 in that the common electrode of the liquid crystal display panel 1 is not used as the detection electrodes 12 (i.e., one of two sets of electrodes constituting the touch sensor). In the first example, as shown in FIG. 10, the detection electrodes 12 are formed on the interlayer insulating film 23, which is formed on the TFT substrate 1a and provided with the pixel electrodes 19. Moreover, the detection electrodes 12 are arranged in the boundary area that surrounds each of the effective areas (where the pixel electrodes 19 are provided) and does not contribute to image display on the liquid crystal display panel 1. Although a plan view (see, e.g., FIG. 8) of the configuration of the first example is omitted, the detection electrodes 12 are provided in the following manner. Frame electrodes are formed so as to coincide with the video signal lines 9 and the scanning signal lines 10 around the pixel electrodes 19 (see FIG. 8). Then, the frame electrodes are connected appropriately in the vertical direction and the horizontal direction, so that a plurality of detection electrodes 12 extending in the horizontal direction are formed as a whole, as shown in FIG. 6. In the configuration of the first example in FIG. 10, since the detection electrodes 12 are formed by adding electrodes other than those used for image display on the liquid crystal display panel 1, the common electrode is not separated by making slits in the horizontal direction.

The detection electrodes 12 formed around the pixel electrode 19 shown in FIG. 10 are made of, e.g., a metal material such as aluminum or copper and indium tin oxide (ITO) covering the metal material.

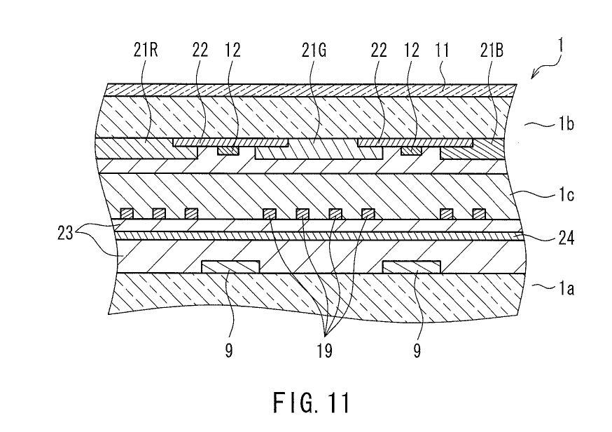

FIG. 11 is a cross-sectional view showing a second example in which the detection electrodes of the touch sensor are formed in a different place in the liquid crystal display panel of this embodiment. Like FIGS. 9 and 10, FIG. 11 illustrates the region represented by A in FIG. 6.

The second example shown in FIG. 11 differs from the first example in the location of the detection electrodes 12 (i.e., one of two sets of electrodes constituting the touch sensor). In the second example, as shown in FIG. 11, the detection electrodes 12 are formed on the black matrix layer 22 that is disposed in the boundary area that surrounds each of the effective areas constituting the sub-pixels on the counter substrate 1b. That is, the detection electrodes 12 are formed on the surface of the black matrix layer 22 that faces the liquid crystal layer. Although a plan view (see, e.g., FIG. 8) of the configuration of the second example is omitted, similarly to the first example, the detection electrodes 12 are provided in the following manner. Frame electrodes are formed on the black matrix layer 22 of the counter substrate 1b at positions corresponding to the video signal lines 9 and the scanning signal lines 10 around the pixel electrodes 19 on the TFT substrate 1a. Then, the frame electrodes are connected appropriately in the vertical direction and the horizontal direction, so that a plurality of detection electrodes 12 extending in the horizontal direction are formed as a whole, as shown in FIG. 6. In the configuration of the second example in FIG. 11, since the detection electrodes 12 are formed by adding electrodes other than those used for image display on the liquid crystal display panel 1, the common electrode is not separated by making slits in the horizontal direction. The detection electrodes 12 formed on the black matrix layer 22 of the counter substrate 1b shown in FIG. 11 are made of, e.g., a metal material such as aluminum or copper.

In the first example of FIG. 10 and the second example of FIG. 11, similarly to the configuration example shown FIG. 9, a transparent conductive material such as indium tin oxide (ITO) or indium zinc oxide (IZO) is patterned on the surface of the counter substrate 1b that faces the viewer side, so that a plurality of driving electrodes 11 extending in the vertical direction are formed.

The configuration of the portions that relate to the image display on the liquid crystal display panel 1 in the first example (FIG. 10) and the second example (FIG. 11) is the same as that shown in FIG. 9. Specifically, the liquid crystal display panel 1 includes the TFT substrate 1a formed of a transparent substrate such as a glass substrate, and the counter substrate 1b located opposite the TFT substrate 1a with a predetermined space between them. The liquid crystal material 1c is sealed between the TFT substrate 1a and the counter substrate 1b to form a liquid crystal layer. The TFT substrate is located on the back surface side of the liquid crystal display panel 1, and the pixel electrodes 19, the TFTs, the common electrode 24, and the like are formed on the surface of the transparent substrate (main body) of the TFT substrate 1a. The pixel electrodes 19 are arranged in a matrix. The TFTs are provided so as to correspond to the respective pixel electrodes 19, and serve as switching elements for turning on/off the application of a voltage to the corresponding pixel electrodes 19. The common electrode 24 is provided so as to be opposed to the pixel electrodes 19 via the interlayer insulating film. The counter substrate 1b is located on the front surface side of the liquid crystal display panel 1, and the color filters 21R, 21G, and 21B of three primary colors and the black matrix 22 are formed on the surface of the transparent substrate (main body) of the counter substrate 1b. The color filters 21R, 21G, and 21B constitute red (R), green (G), and blue (B) sub-pixels, respectively, and are arranged at positions overlapping (corresponding to) the respective pixel electrodes 19 provided on the TFT substrate 1a in the thickness direction of the liquid crystal display panel 1. The black matrix 22 serves as a light-shielding portion made of a light-shielding material for enhancing the contrast of an image to be displayed. The black matrix 22 is arranged between the RGB sub-pixels and between the pixels, each of which is composed of the three sub-pixels.

As described above, in the liquid crystal display device of this embodiment, the detection electrodes 12 may be provided in the following manner. First, the common electrode also can be used as the detection electrodes 12. Second, the detection electrodes 12 can be arranged in a grid pattern on the TFT substrate 1a so as to correspond to the boundary area that surrounds each of the pixel electrodes 19. Alternatively, the detection electrodes 12 can be arranged in a grid pattern on the counter substrate 1b so as to surround each of the effective areas constituting the sub-pixels. Then, such grid electrodes are connected appropriately in the horizontal direction and the vertical direction, so that a plurality of detection electrodes 12 extending in the horizontal direction can be formed, as shown in FIG. 2. The detection electrodes 12 thus formed are arranged so as to cross the driving electrodes 11 that are formed on the surface of the counter substrate 1b that faces the viewer side, and a capacitive element is formed at each of the crossed portions, thereby functioning as a capacitive Touch Panel Screen.

Next, a detection operation of a touch position of a touch sensor in the liquid crystal display device of this embodiment will be described.

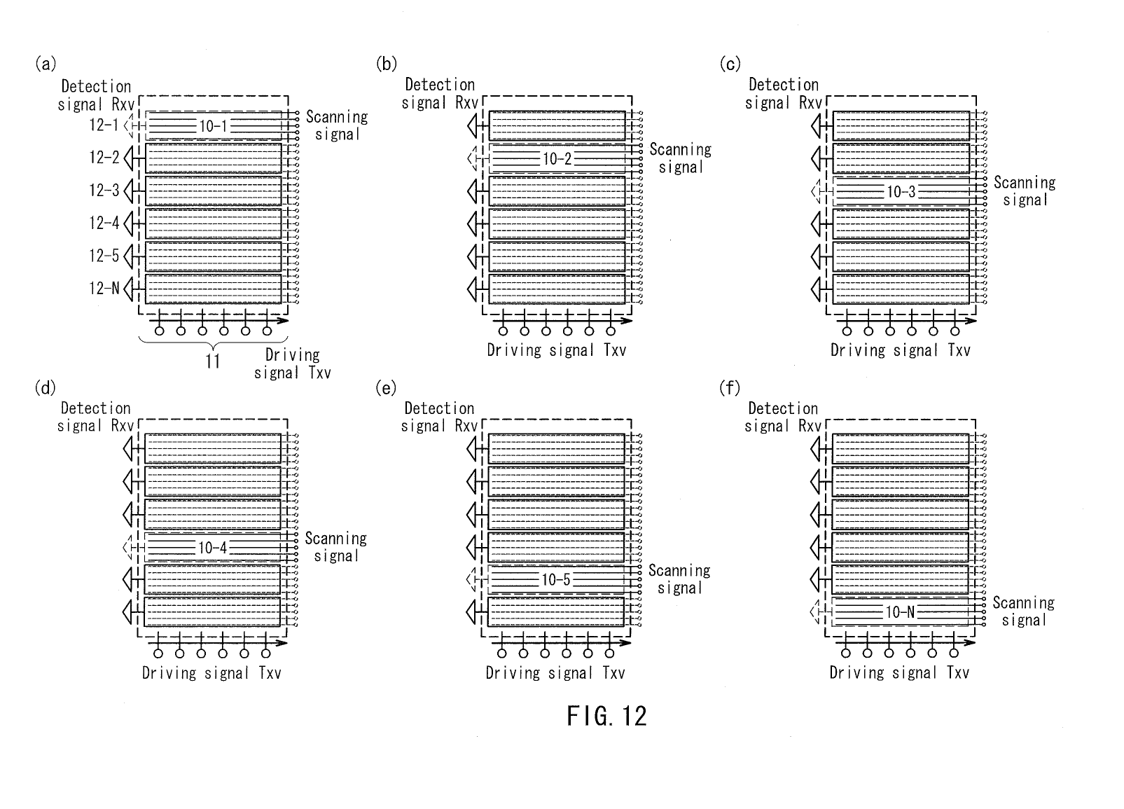

FIG. 12 is a diagram for explaining an example of the relationship between (i) timing at which a scanning signal is input to each line block of the scanning signal lines to update a display image on the liquid crystal display panel of this embodiment and (ii) timing at which a driving signal is applied to the driving electrodes and a detection signal is acquired from each of the detection electrodes in order to detect a touch position of the touch sensor. FIGS. 12(a) to 12(f) illustrate the state during the period in which each line block of the scanning signal lines is being scanned.

As shown in FIG. 12(a), during the scanning period in which a scanning signal is input sequentially to each of the scanning signal lines in the first (uppermost) line block 10-1, a driving signal Txv is supplied one or more times to each of the driving electrodes 11 so that scanning is performed successively in the horizontal direction as indicated by the arrow in FIG. 12(a). At this time, the touch sensor does not perform a detection operation in the detection electrode 12-1 corresponding to the line block 10-1 to which the scanning signal is being input, but performs a detection operation in the other detection electrodes 12 (12-2 to 12-N), except for the detection electrode 12-1, corresponding to the line blocks of the scanning signal lines to which no scanning signal is being input. Thus, detection signals Rxv are output from the other detection electrodes 12.

Next, as shown in FIG. 12(b), during the scanning period in which a scanning signal is input sequentially to each of the scanning signal lines in the second line block 10-2, a driving signal Txv is supplied one or more times to each of the driving electrodes 11 so that scanning is performed successively. At this time, the touch sensor does not perform a detection operation in the detection electrode 12-2 corresponding to the line block 10-2 to which the scanning signal is being input, but performs a detection operation in the other detection electrodes 12 (12-1, 12-3 to 12-N), except for the detection electrode 12-2. Thus, detection signals Rxv are output from the other detection electrodes 12.

Subsequently, as shown in FIGS. 12(c) to 12(f), the scanning period in which a scanning signal is input sequentially to each of the scanning signal lines proceeds in the order of the line blocks 10-3, 10-4, 10-5, . . . 10-N. During this scanning period, the touch sensor does not perform a detection operation in the detection electrodes 12-3, 12-4, 12-5, . . . 12-N corresponding to the line blocks 10-3, 10-4, 10-5, . . . 10-N to which the scanning signal is being input, but performs a detection operation in the other detection electrodes 12. Thus, detection signals Rxv are output from the other detection electrodes 12. At this time, a driving signal Tvx is supplied one or more times to each of the driving electrodes 11 during every scanning period in which the scanning signal is input sequentially to each of the scanning signal lines in the respective line blocks.

In the liquid crystal display device of this embodiment, the detection operation is performed by using a plurality of detection electrodes 12 corresponding to the line blocks in which no scanning signal is being applied to the scanning signal lines. When a scanning signal is applied to a scanning signal line and the TFTs connected to this scanning signal line are turned on, a voltage is applied from the video signal lines to the pixel electrodes corresponding to the TFTs that have been turned on. Such an operation of updating the image display increases or decreases the voltage of the pixel electrodes. Therefore, charge is transferred by capacitive coupling between the pixel electrodes and the detection electrode. Consequently, the charge transfer that is irrelevant to the touch operation may occur in the detection electrode 12 and become noise of a touch position detection signal. Moreover, charge also is transferred by capacitive coupling between the scanning signal line to which a scanning signal is being applied and the detection electrode, and this charge transfer may become noise of the touch position detection signal. Thus, the touch sensor provided in the liquid crystal display device of this embodiment performs a detection operation so that a detection signal Rxv is not output from the detection electrode arranged in the line block in which the scanning signal lines are selected, as shown in FIG. 12. This can prevent the detection of noise in the detection electrode 12 and improve the touch position detection sensitivity of the touch sensor.

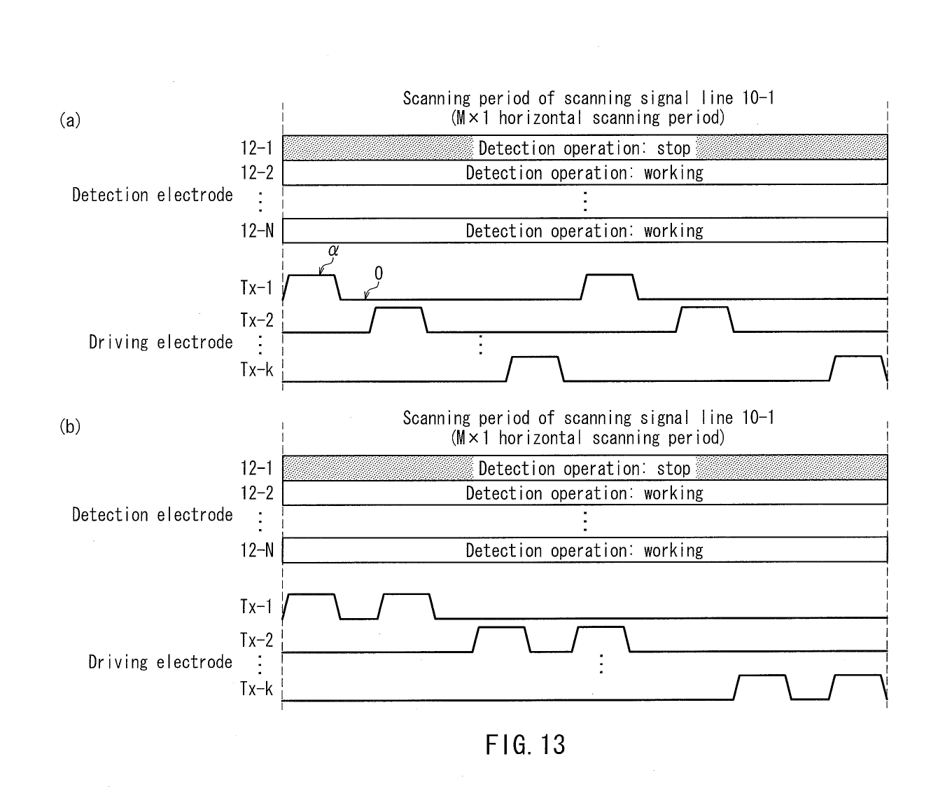

FIGS. 13(a) and 13(b) are diagrams for explaining an example of the relationship between a detection operation of the detection electrodes and a driving signal applied to the driving electrodes during the scanning period of the scanning signal lines in the line block 10-1, as shown in FIG. 12(a). FIGS. 13(a) and 13(b) show an example in which two pulse waveforms are applied as a driving signal to one driving electrode 11 during the scanning period of the scanning signal lines in the line block 10-1.

As shown in the upper diagrams of FIGS. 13(a) and 13(b), during the touch detection period, the detection electrode 12-1 corresponding to the line block 10-1 to which a scanning signal is being applied is stopped and a detection operation is not performed, while a detection operation is performed in the detection electrodes other than the detection electrode 12-1. As shown in the lower diagrams of FIGS. 13(a) and 13(b), a pulse waveform having a potential difference between a voltage of 0 V (=GND) level and an amplitude α of the driving signal is applied sequentially to the driving electrodes Tx-1 to Tx-k.

In FIG. 13(a), a pulse voltage is applied sequentially to the driving electrode Tx-1, the next driving electrode Tx-2, and the following driving electrodes. After a pulse voltage is applied to the last driving electrode Tx-k, a pulse voltage again is applied to the first driving electrode Tx-1. Then, a pulse voltage is applied sequentially to the next driving electrode Tx-2 to the last driving electrode Tx-k. In this manner, the pulse voltage (driving signal) is applied sequentially to each of the driving electrodes 11 so that scanning is performed twice until the end of the scanning period of the scanning signal lines in the line block 10-1.

Like the operation during the scanning period of the first line block 10-1, a driving signal is applied sequentially to each of the driving electrodes (Tx-1 to Tx-k) so that scanning is performed successively twice during the scanning period of the scanning signal lines in the next line block 10-2. Then, a driving signal is applied sequentially to the driving electrodes (Tx-1 to Tx-k) in the same manner during the scanning period of the scanning signal lines from the third line block 10-3 to the last line block 10-N.

FIG. 13(a) shows an example in which one pulse waveform is applied sequentially to each of the driving electrodes so that scanning is performed successively twice, and thus two pulse waveforms in total are applied to one driving electrode. There is another example of the method for applying two driving signal pulses to each of the driving electrodes during the scanning period of the scanning signal lines in one line block. As shown in FIG. 13(b), two pulse waveforms may be applied continuously together to each of the driving electrodes, while all the driving electrodes are scanned once.

As shown in FIG. 13(b), two pulse waveforms are applied sequentially so that all the driving electrodes are scanned during the scanning period of the scanning signal lines in the first line block 10-1. Thus, detection signals can be output from the detection electrodes (12-2 to 12-N) corresponding to the line blocks other than the first line block 10-1. In this case, similarly to the example shown in FIG. 13(a), a driving signal of two pulse waveforms is applied sequentially to all the driving electrodes during the scanning period of the scanning signal lines in the second and the following line blocks, and detection signals can be output from the detection electrodes corresponding to the non-selected line blocks.

As shown in FIGS. 13(a) and 13(b), when two driving signal pulses are applied to each of the driving electrodes during the period in which one line block is selected, and a touch position is detected twice for each of the detection electrodes, the frequency of the detection of the touch position is increased, compared to the case where a driving signal pulse is applied once to each of the driving electrodes. Therefore, the detection accuracy of a touch position can be improved. Moreover, the number of driving signal pulses to be applied to the driving electrodes 11 may be increased to three or more, thereby improving the detection accuracy of a touch position further.

Although not shown in FIGS. 13(a) and 13(b), the voltage of the detection electrode is at the same potential as the voltage of the common electrode. When the common electrode 24 also is used as the detection electrodes 12 in the liquid crystal display panel 1, as shown in FIG. 9, the potential is applied to the detection electrode as the common electrode. Instead of using the common electrode 24 as the detection electrodes 12, when the detection electrodes 12 are arranged around each of the pixel electrodes 19 on the TFT substrate 1a in the liquid crystal display panel 1, as shown in FIG. 10, or when the detection electrodes 12 are formed on the black matrix layer 22 of the counter substrate 1b that faces the portions around the pixel electrodes 19, as shown in FIG. 11, setting the voltage of the detection electrode at the same potential as the voltage of the common electrode also is advantageous in effectively preventing the liquid crystal molecules from being oriented in the wrong direction due to the electric field from the detection electrodes. Thus, a touch position can be detected without adversely affecting the display image.

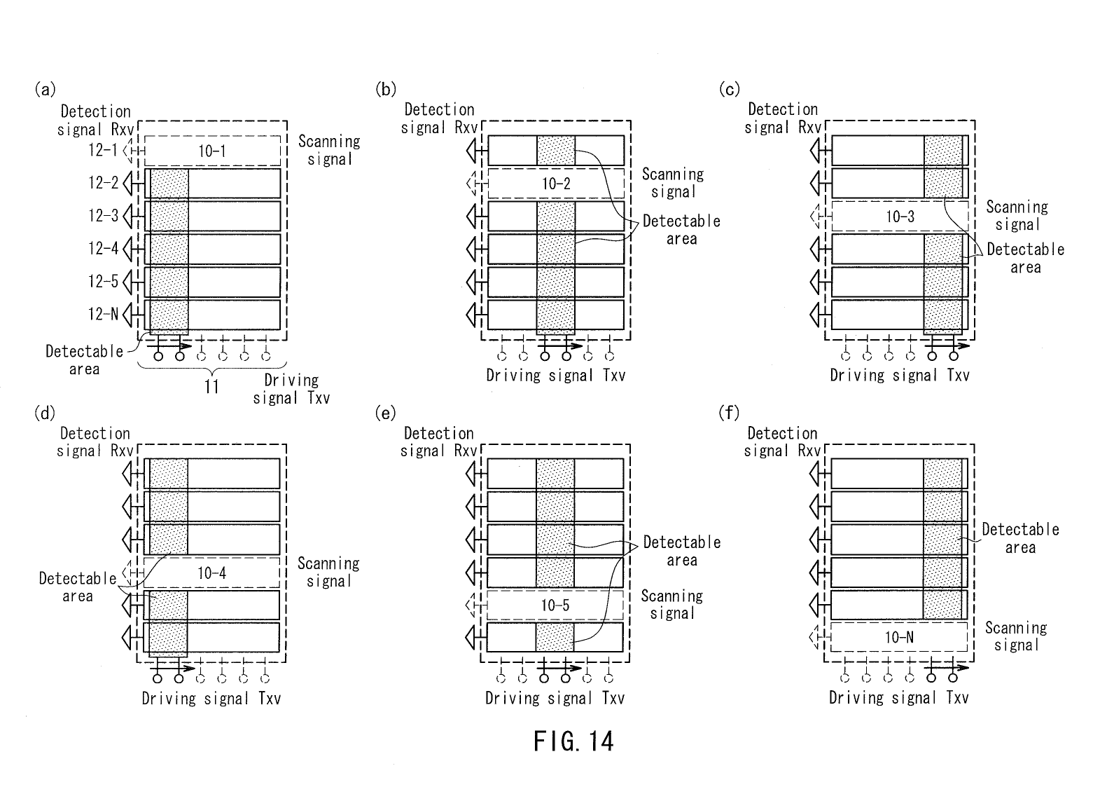

FIG. 14 is a diagram for explaining another example of the input of a scanning signal to a line block of the scanning signal lines for updating the display of the liquid crystal display panel, and the application of a driving signal to the driving electrodes and the acquisition of a detection signal from each of the detection electrodes for detecting a touch position of the touch sensor. FIGS. 14(a) to 14(f) illustrate the state during the period in which each line block of the scanning signal lines is being scanned. In FIG. 14, the scanning signal lines are omitted.

The acquisition timing of a detection signal shown in FIG. 14 is the same as that shown in FIG. 12 in that a detection signal is not output from the detection electrode corresponding to the selected line block in which a scanning signal is applied sequentially to the scanning signal lines, and detection signals are output from the detection electrodes corresponding to the non-selected line blocks. The example of FIG. 14 differs from the example of FIG. 12 in a method for sequentially applying a driving signal to the driving electrodes during the scanning period of the scanning signal lines in each line block. Specifically, in the example of FIG. 12, a driving signal is applied at least once so that all the driving electrodes are scanned sequentially during the scanning period of the scanning signal lines in each line block. On the other hand, in the example of FIG. 14, the number of times a driving signal is applied to the driving electrodes is less than 1 during the scanning period of the scanning signal lines in each line block.

In FIG. 14, a driving signal is applied to one-third of the total driving electrodes (i.e., two out of the total six electrodes) during the period in which a scanning signal is being applied to one line block. As shown in FIG. 14(a), a driving signal Txv is applied to two driving electrodes on the left of FIG. 14(a) during the period in which a scanning signal is being applied to the scanning signal lines in the first line block 10-1. As shown in FIG. 14(b), a driving signal Txv is applied to two driving electrodes in the center of FIG. 14(b) during the period in which a scanning signal is being applied to the scanning signal lines in the second line block 10-2. As shown in FIG. 14(c), a driving signal Txv is applied to two driving electrodes on the right of FIG. 14(c) during the period in which a scanning signal is being applied to the scanning signal lines of the third line block 10-3. In this manner, a driving signal Tvx is applied so that all the driving electrodes are scanned sequentially during the period in which a plurality of line blocks (i.e., three line blocks in the example of FIG. 14) are selected and a scanning signal is being applied to the selected line blocks.

As described above, the number of times a driving signal is applied to the driving electrodes is less than 1 during the period in which one line block is selected. In other words, the driving signal is applied so that all the driving electrodes are scanned sequentially during the period in which a plurality of line blocks are selected. Consequently, the detectable area of a touch position during the period in which one line block is selected is limited to a range in which the driving signal is being applied to the driving electrodes, as indicated by FIGS. 14(a) to 14(f) that show the detectable areas. However, when a proportion of the driving electrodes to which a driving signal is to be applied during the period in which one line block is selected is determined in view of the number of line blocks of the display panel, it is possible to obtain the touch position information in the entire image display area during one frame period of the image display. Therefore, there is no problem in detecting the touch position information even if the number of times a driving signal is applied to the driving electrodes is less than 1 during the period in which one line block is selected, as shown in FIG. 14.

For example, in the case of a large display panel, the driving electrodes need to be arranged at predetermined intervals regardless of the size of the display panel in terms of the detection accuracy of a touch position. This results in an increase in the number of the driving electrodes arranged on the display panel. On the other hand, the length of one frame period defined by a video signal is unchanged. Therefore, the scanning speed has to be increased in order to apply a driving signal to all the driving electrodes during one frame period. Such a difficulty can be avoided by using the method for detecting a touch position in which the number of times a driving signal is applied to the driving electrodes is less than 1 during the period in which one line block is selected, as shown in FIG. 14. Thus, a touch position on a large display panel can be detected favorably.

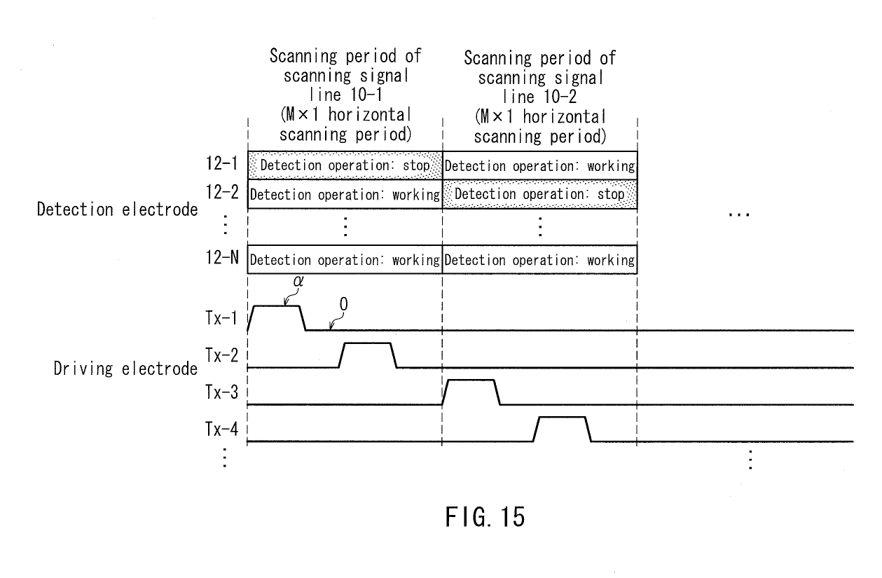

FIG. 15 is a diagram for explaining an example of the relationship between a detection operation of the detection electrodes and a pulse voltage (driving signal) applied to the driving electrodes when the number of times a driving signal is applied to the driving electrode is less than 1 during the scanning period of the scanning signal lines in each line block, as shown in FIGS. 14(a) to 14(f).

As shown in the upper diagram of FIG. 15, during the period in which a scanning signal is being applied to the first line block 10-1, a detection operation is not performed in the detection electrode 12-1 corresponding to the line block 10-1, while a detection operation is performed in the detection electrodes other than the detection electrode 12-1. Next, during the period in which a scanning signal is being applied to the second line block 10-2, a detection operation is not performed in the detection electrode 12-2 corresponding to the line block 10-2, while a detection operation is performed in the detection electrodes other than the detection electrode 12-2. As shown in the lower diagram of FIG. 15, a pulse waveform having a potential difference between a voltage of 0 V (=GND) level and an amplitude α of the driving signal is applied to the driving electrodes.

According to FIG. 14, FIG. 15 shows that a pulse voltage is applied to each of two driving electrodes during the scanning period of the scanning signal lines in each line block. Specifically, a pulse voltage is applied to the driving electrode Tx-1, and then a pulse voltage is applied to the driving electrode Tx-2 during the period in which the first line block 10-1 is selected. Subsequently, a pulse voltage is applied to the driving electrode Tx-3, and then a pulse voltage is applied to the driving electrode Tx-4 during the scanning period of the scanning signal lines in the second line block 10-2. Although not shown in FIG. 15, a pulse voltage further is applied to each of the next two driving electrodes repeatedly during the period in which a scanning signal is being applied to the scanning signal lines in the third and the following line blocks. Thus, the number of times a driving signal is applied to the driving electrodes can be less than 1 during the period in which one line block is selected. In other words, the driving signal can be applied so that all the driving electrodes are scanned sequentially during the period in which a plurality of line blocks are selected.

Although not shown in FIG. 15, the voltage of the detection electrode is at the same potential as the voltage of the common electrode. Therefore, when the common electrode also is used as the detection electrodes in the liquid crystal display panel, an appropriate voltage is applied to the common electrode. Instead of using the common electrode as the detection electrodes, even if the grid-like detection electrodes are added in the liquid crystal display panel, it is possible effectively to prevent the liquid crystal molecules from being oriented in the wrong direction due to the electric field from the detection electrodes. Thus, a touch position can be detected without adversely affecting the display image.

As described above, in the touch sensor of the present technology, the detection electrodes 12 are formed in parallel to the scanning signal lines 10, and the driving electrodes 11 are formed in parallel to the video signal lines 9, i.e., formed so as to cross the detection electrodes 12. A touch position can be detected by applying a driving signal to the driving electrodes 11 and detecting a detection signal output from each of the detection electrodes 12 during the touch detection period.

During the touch detection period, a detection operation is not performed in the detection electrode 12 in close proximity to the scanning signal line 10 to which the scanning signal is being applied, and a detection operation is performed in the detection electrodes 12 in close proximity to the scanning signal lines 10 to which the scanning signal is not being applied.

More specifically, the touch sensor is provided in the display device that includes a plurality of scanning signal lines 10 that are grouped into N line blocks, each line block having M scanning signal lines, and that updates the display by sequentially applying a scanning signal to the scanning signal lines during one frame period. The touch sensor includes a plurality of driving electrodes 11 and a plurality of detection electrodes 12 that are arranged so as to cross each other, and capacitive elements that are formed between the driving electrodes 11 and the detection electrodes 12. The detection electrodes 12 are arranged parallel to the scanning signal lines 10 of the display device so as to correspond to the respective N line blocks 10-1, 10-2, . . . , 10-N of the scanning signal lines 10. A touch position is detected by applying a driving signal to the driving electrodes 11 and detecting a detection signal output from each of the detection electrodes 12-1, 12-2, . . . , 12-N during the touch detection period.

During the touch detection period, a detection operation is not performed in the detection electrode corresponding to the line block of the scanning signal lines to which a scanning signal is being applied, and a detection operation is performed in the detection electrodes corresponding to the line blocks of the scanning signal lines to which no scanning signal is being applied.

With the above configuration of the touch sensor (input device) of the present technology, the operation of updating the display of the display device can be performed at the same time as the detection operation of the touch sensor. Thus, the input device easily can achieve a high resolution and a large size.

In the above embodiment, the detection electrodes 12 of the touch sensor, which are arranged parallel to the scanning signal lines 10, are provided between the TFT substrate 1a and the counter substrate 1b of the liquid crystal display panel 1. Moreover, the driving electrodes 11 of the touch sensor, which are arranged so as to cross the detection electrodes 12, are provided on the surface of the counter substrate 1b that is located on the front surface side of the liquid crystal display panel 1. However, the configurations of the input device and the liquid crystal display device of the present technology are not limited to those described in this embodiment.

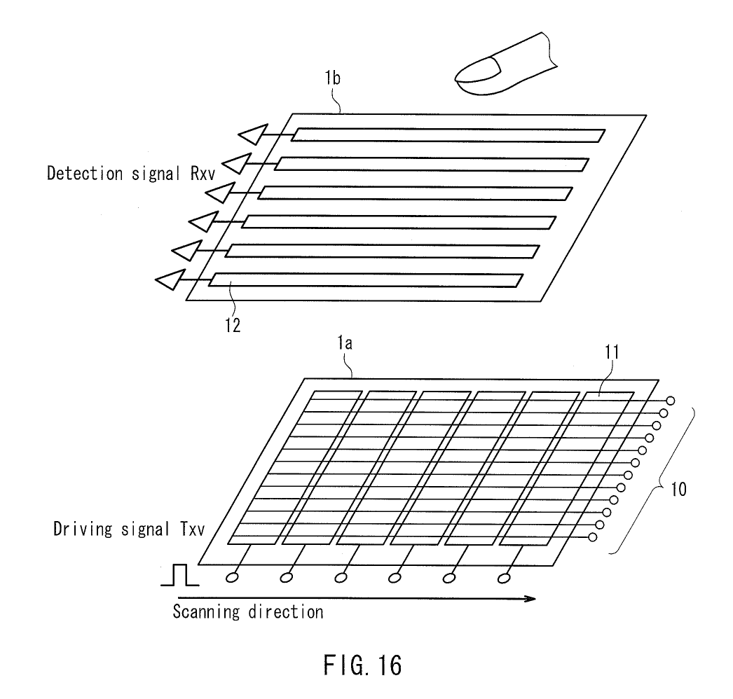

FIG. 16 is an exploded perspective view showing another example of the arrangement of the driving electrodes and the detection electrodes constituting the touch sensor (input device) of the present technology.

The example shown in FIG. 16 differs from the example of the electrode arrangement of the input device of the above embodiment shown in FIG. 2 in that the arrangement of the detection electrodes 12 and the driving electrodes 11 are reversed.

Specifically, the driving electrodes 11 extending in the vertical direction are formed on the TFT substrate 1a that is located on the back surface side of the liquid crystal display panel. The detection electrodes 12 extending in the horizontal direction are formed on the front surface of the counter substrate 1b that is located on the front surface side of the liquid crystal display panel.

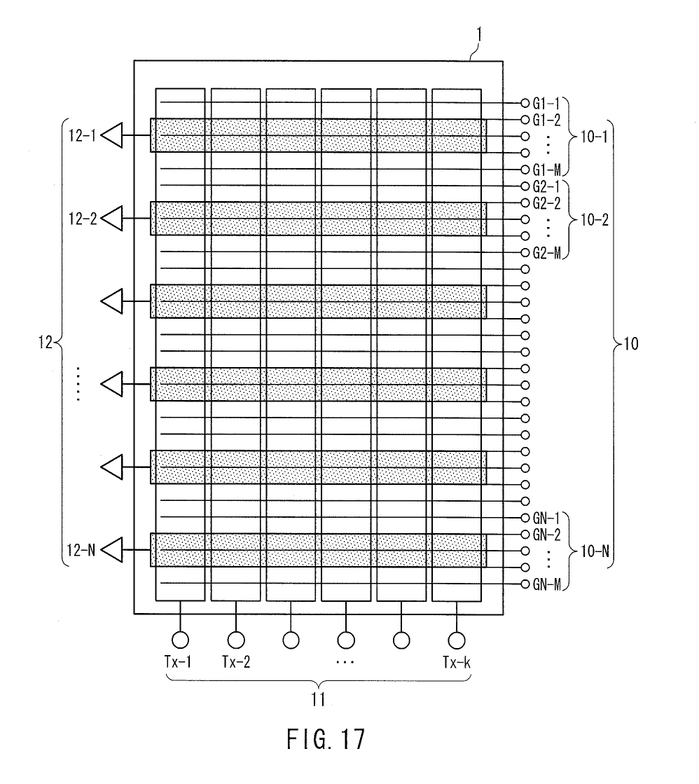

FIG. 17 is a schematic diagram showing an arrangement structure of the scanning signal lines of the liquid crystal display panel and an arrangement structure of the driving electrodes and the detection electrodes of the touch sensor when the touch sensor (input device) has the electrode arrangement shown in FIG. 16.

As shown in FIG. 17, the scanning signal lines 10 extending in the horizontal direction are divided into a plurality of N (N is a natural number) line blocks 10-1, 10-2, . . . , 10-N, and each line block has M (M is a natural number) scanning signal lines G1-1, G1-2, . . . , G1-M.

The detection electrodes 12 of the touch sensor are arranged so that N detection electrodes 12-1, 12-2, . . . , 12-N extending in the horizontal direction correspond to the line blocks 10-1, 10-2, . . . , 10-N, respectively. Then, a plurality of driving electrodes 11 (Tx-1, Tx-2, . . . , Tx-k) are arranged so as to cross the N detection electrodes 12-1, 12-2, . . . , 12-N.

In the example of the electrode arrangement of the input device shown in FIGS. 16 and 17, the width of each of the detection electrodes 12 formed on the counter substrate is reduced to increase the space between the adjacent detection electrodes 12. According to the principle of detecting a touch position of the capacitive Touch Panel Screen (input device) of the present technology, as described with reference to FIG. 3, when the user's finger is close to the electrodes located on the front surface side, the input device detects a change in capacitance as a voltage value or a current value. Therefore, if the space between the electrodes located on the front surface side is narrow, the capacitance is not likely to change by bringing the user's finger into proximity to the electrodes. Thus, when the driving electrodes 11 are formed on the counter substrate that is located on the front surface side, as shown in FIGS. 2 and 5, the width of each of the driving electrodes 11 is reduced to increase the space between the adjacent driving electrodes 11.

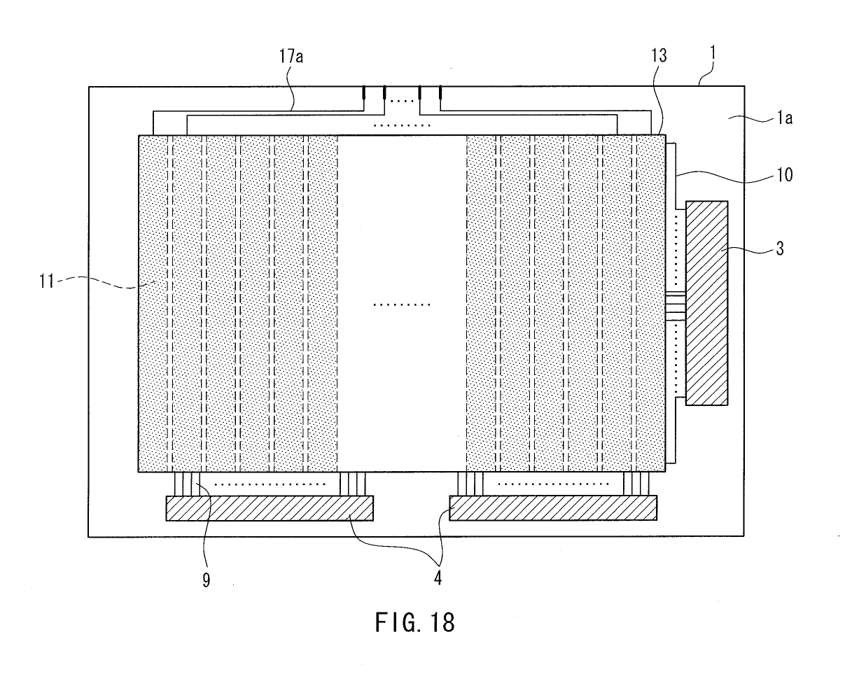

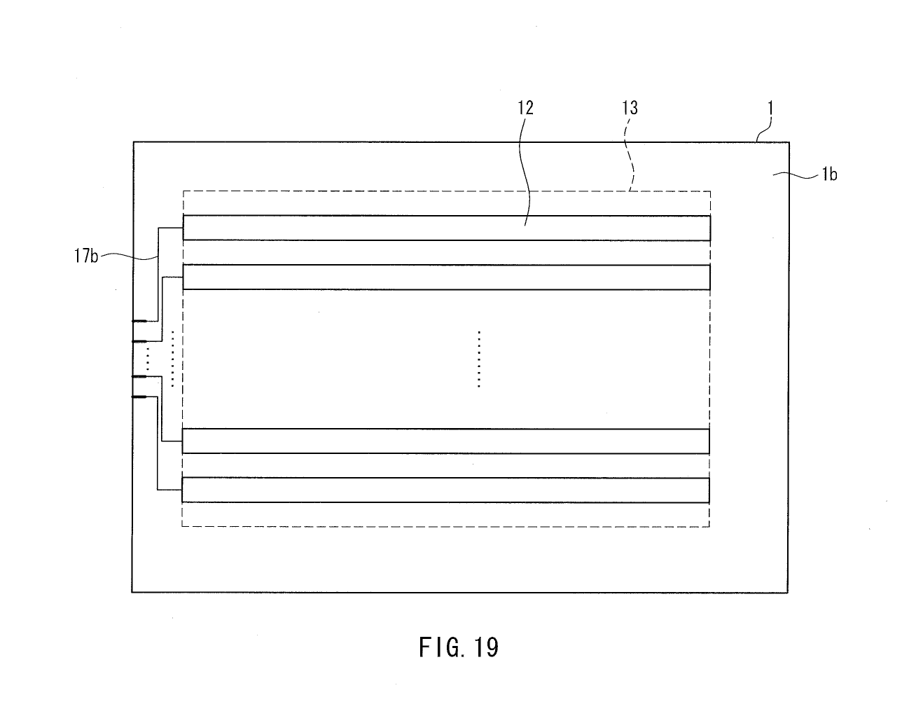

FIGS. 18 and 19 are diagrams for explaining a configuration of the liquid crystal display panel of the liquid crystal display device having the touch sensor function when the arrangement of the driving electrodes and the detection electrodes is changed, as shown in FIG. 16. FIG. 18 shows a configuration of the TFT substrate 1a of the liquid crystal display panel 1 and corresponds to FIG. 6 of the above embodiment. FIG. 19 shows a configuration of the counter substrate 1b of the liquid crystal display panel 1 and corresponds to FIG. 7 of the above embodiment. FIGS. 18 and 19 and FIGS. 6 and 7 differ only in the configuration of the driving electrodes 11 and the detection electrodes 12 of the touch sensor (input device), and are the same in the configuration of the electrodes or the like used for image display on the liquid crystal display panel 1. Therefore, the same components as those in FIGS. 6 and 7 are denoted by the same reference numerals, and the explanation will not be repeated. Like FIGS. 6 and 7, FIGS. 18 and 19 illustrate the respective substrates when viewed from the front surface side of the liquid crystal display panel 1, i.e., from the direction in which a viewer sees the displayed image.

In the example of the electrode arrangement shown in FIGS. 18 and 19, the driving electrodes 11 are formed on the TFT substrate 1a so as to be parallel to the video signal lines 9 extending in the vertical direction. Moreover, the driving electrodes 11 are arranged in the image display area 13 where the pixel electrodes, the TFTs, the common electrode, etc. are arranged.

The driving electrodes 11 may be provided in the following manner. As in the case of the detection electrodes shown in the examples of FIGS. 10 and 11, the grid electrodes are formed on the TFT substrate 1a or the counter substrate 1b in the liquid crystal display panel 1 so as to correspond to the boundary area that does not contribute to image display on the liquid crystal display panel 1. Then, the grid electrodes are connected appropriately. This results in a plurality of electrodes having a predetermined width and extending in the vertical direction, as shown in FIG. 18.

As shown in FIG. 19, a known transparent conductive material such as indium tin oxide (ITO) or indium zinc oxide (IZO) is patterned on the front surface of the counter substrate 1b (on the viewer side), which is on the other side of the surface provided with the color filter layer or the like in the image display area 13, so that a plurality of detection electrodes 12 extending in the raw direction (horizontal direction of the pixel array are formed. Thus, the driving electrodes 11 are arranged on the TFT substrate 1a and the stripe-shaped detection electrodes 12 are arranged on the counter substrate 1b.

In another example of the electrode arrangement shown in FIGS. 18 and 19, the terminal extraction portions 17a, 17b are provided to connect electrically the driving electrodes 11 and the detection electrodes 12 to the sensor driving circuit 6 and the signal detection circuit 7 (not shown in FIGS. 18 and 19), respectively. The terminal extraction portions 17a, 17b are formed into so-called solid patterns with a large width in order to reduce the resistance value and improve the detection accuracy and the detection speed. The terminal extraction portions 17a, 17b are preferably made of a low-resistance metal material (aluminum, copper, etc.).

As described above, one of the plurality of driving electrodes and the plurality of detection electrodes constituting the touch sensor (input device) is located inside a pair of glass substrates of the display panel, and the other is located on the surface of the pair of glass substrates that faces the viewer side. This configuration can provide an input device that is integrated with an image display panel such as a liquid crystal display panel, and an image display device that is integrated with the input device.

In the input device of the present technology, the arrangement structure of the detection electrodes and the driving electrodes constituting the touch sensor is not limited to the above two examples. As long as a touch position on the front surface of the display panel touched by the user can be detected, the driving electrodes 11 arranged on the front surface of the counter substrate 1b may be located inside the liquid crystal display panel 1, as with the detection electrodes 12, in the input device of the embodiment shown in FIGS. 2 to 15. Moreover, the detection electrodes 12 arranged on the front surface of the counter substrate 1b may be located inside the liquid crystal display panel 1, as with the driving electrodes 11, in the input device of the embodiment shown in FIGS. 16 to 19.

A transparent protective substrate generally is formed on the counter substrate of the liquid crustal panel to protect the polarizing plate, the liquid crystal display panel, etc. from an impact or the like. Therefore, the driving electrodes 11 arranged on the front surface of the counter substrate 1b may be disposed at any position between the surface of the protective substrate that faces the liquid crystal display panel and the surface of the counter substrate 1b that faces the viewer side in the input device of the embodiment shown in FIGS. 2 to 15. Moreover, the detection electrodes 12 arranged on the front surface of the counter substrate 1b may be disposed at any position between the surface of the protective substrate that faces the liquid crystal display panel and the surface of the counter substrate 1b that faces the viewer side in the input device of the embodiment shown in FIGS. 16 to 19.

In short, the input device of the present technology can be configured so that at least one of the plurality of detection electrodes 12 and the plurality of driving electrodes 11 is located inside the display panel, and the detection electrodes 12 are arranged parallel to the scanning signal lines 10. When the driving electrodes 11 are located inside the liquid crystal display panel 1, a driving signal to be applied to the driving electrodes is a pulse voltage in which a reference potential 0 (0 V (=GND)) is at the same potential as that of the common electrode, and a voltage value in the high period (α) of the pulse is obtained by adding the voltage value of the common electrode and the potential difference (amplitude α), as shown in FIGS. 13 and 15.

Hereinafter, an output operation of a touch position detection signal in the input device of the present technology will be described.

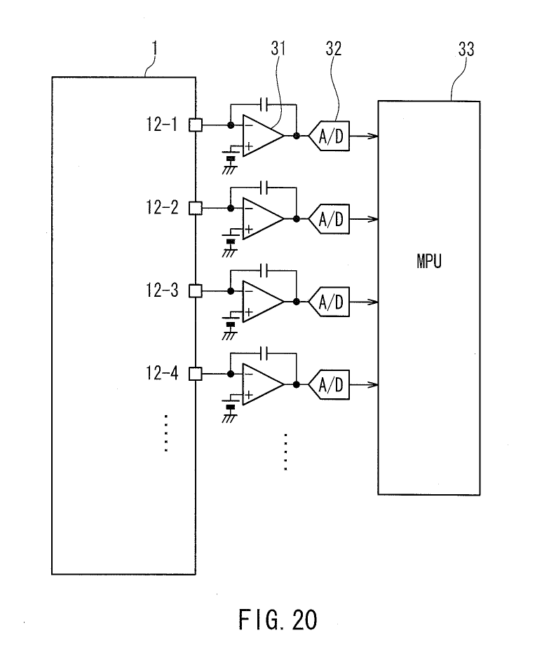

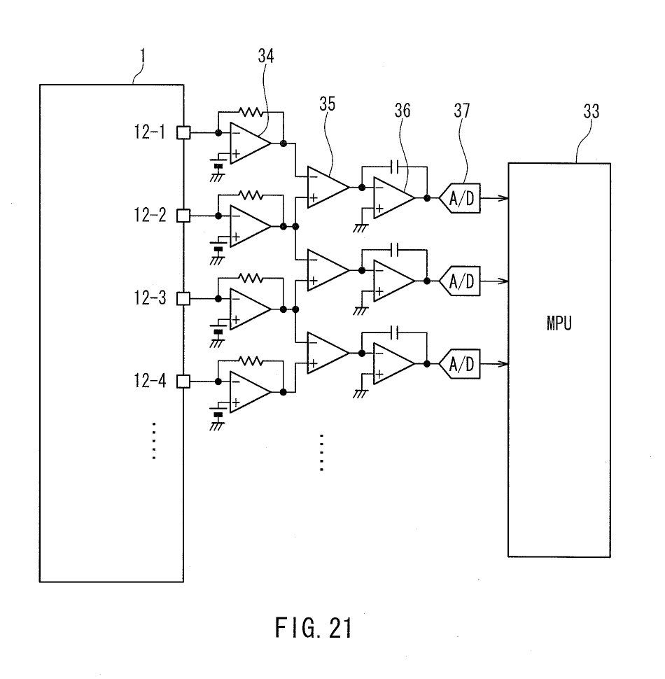

FIGS. 20 and 21 are block diagrams for explaining a configuration of an output circuit of the signal detection circuit 7 that outputs a detection signal of the detection electrode from which a capacitance value is detected due to a driving signal pulse applied to the driving electrodes in the input device of the present technology.

As shown in FIG. 20, output current values of the detection electrodes 12 (12-1, 12-2, 12-3, 12-4, . . . ) arranged in the liquid crystal display panel 1 are integrated by integrators 31 connected to the respective detection electrodes 12, converted into digital values by A/D converters 32, and then output to an arithmetic element (MPU) 33 that performs arithmetic processing of the signals. In FIG. 20, a voltage source connected to the integrators 31 is a power supply for applying a desired voltage to the detection electrodes.

On the other hand, the configuration shown in FIG. 21 differs from FIG. 20 in that the integrated values of the output current values of the detection electrodes 12 (12-1, 12-2, 12-3, 12-4, . . . ) are not converted directly into digital values and then output. Specifically, the output current waveforms are changed into voltage signals by current-to-voltage converters 34 connected to the respective detection electrodes 12, and differences between each of the detection signals of the adjacent detection electrodes are determined by differential amplifiers 35. Only the differences between each of the detection signals of the adjacent detection electrodes are integrated by integrators 36, converted into digital values by A/D converters 37, and then output to the arithmetic element (MPU) 33 that performs arithmetic processing of the signals. In FIG. 21, a power supply for applying a desired voltage to the detection electrodes is connected to the current-to-voltage converters 34.

As shown in FIG. 21, since the differences between each of the detection signals of the adjacent detection electrodes are determined, amplified, and A/D converted, the digital signals can be obtained after the DC components have been removed from the detection electrodes. Therefore, there is no need for a high accuracy A/D converter, and the input device can be provided at a low cost.

Moreover, when a video signal (image display signal) applied to the display panel becomes noise of the detection signal, the detection accuracy of a touch position is reduced. However, such a situation effectively can be eliminated by determining the differences between each of the detection signals of the adjacent detection electrodes. The video signal to be applied to each of the video signal lines of the display panel differs depending on the content of the display image. In the input device of the present technology, since the detection electrodes cross at right angles to the video signal lines of the display panel, an average of the voltage fluctuations of the video signal lines appears as noise on the detection electrodes. Therefore, the noise levels of the adjacent detection electrodes are about the same, and such common mode noise can be cancelled by determining the differences between each of the detection signals of the adjacent detection electrodes. The circuit configuration shown in FIG. 20 may be modified in such a manner that after the detection signals output from the detection electrodes have been amplified and A/D converted, the differences between each of the detection signals of the adjacent detection electrodes are determined. The modified circuit configuration also is useful in terms of effectively eliminating the common mode noise caused by the video signal that is added to the detection signals output from the detection electrodes.

In the input device of this embodiment, as shown in FIGS. 20 and 21, the detection signals output from the detection electrodes pass through the signal detection circuit and are subjected to the arithmetic processing by the arithmetic element (MPU) 33. Then, the result of the arithmetic processing is output to the outside as a touch signal that indicates a touch position. Thus, the detection signals of the detection electrodes are not output directly to the outside, but instead the result of the arithmetic processing is output as the touch position information. This configuration optionally can change the timing of the application of a driving signal to the driving electrodes or the timing of the acquisition of a detection signal from each of the detection electrodes. Consequently, the touch signal indicating the touch position can be output from the signal detection circuit to the outside at desired timing. As described with reference to FIGS. 12 and 13, therefore, even if a touch position in a line block to which a scanning signal is being applied for image display cannot be detected during the period in which the line block is selected, the touch position information in the entire image display area can be obtained by combining the touch position information during one flame period of the image display.

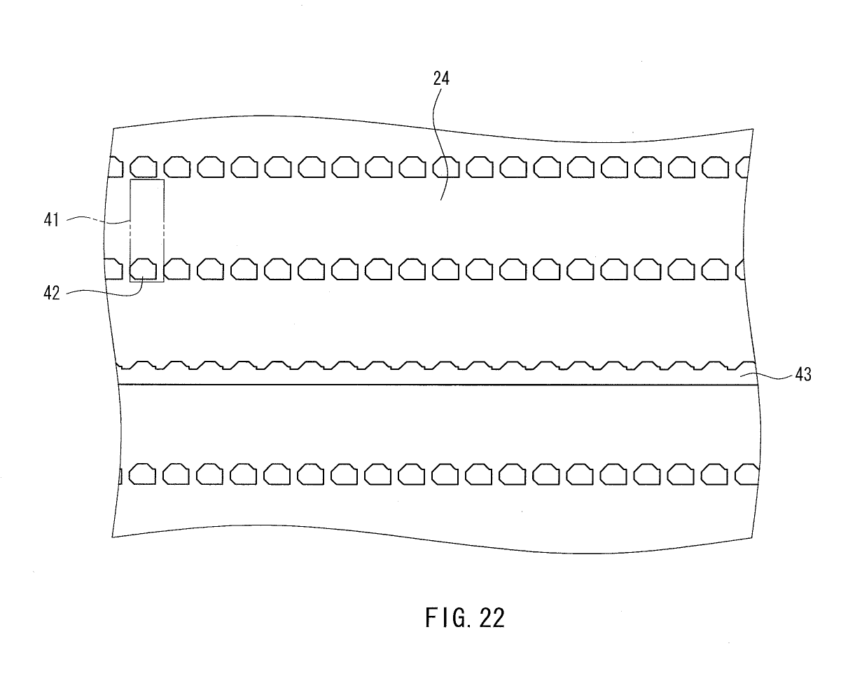

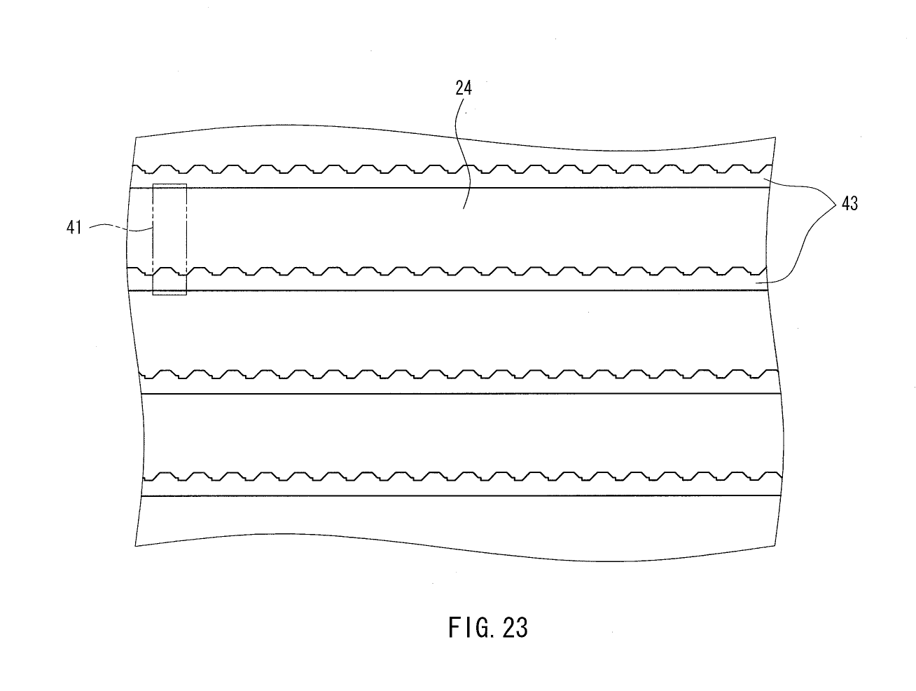

FIGS. 22 and 23 are diagrams for explaining first and second examples of the configuration of the common electrode 24 when the common electrode 24 of the liquid crystal display panel 1 also is used as the detection electrodes 12 of the input device, respectively.

FIG. 22 is an enlarged plan view showing a first example of the configuration of the common electrode 24. In FIG. 22, a region 41 of the common electrode 24, which is indicated by an alternate long and two short dashes line, corresponds to one sub-pixel for one pixel electrode 19.

As shown in FIG. 22, the common electrode 24 has openings 42 to connect the pixel electrodes arranged in an upper layer of the common electrode 24 to the TFTs arranged in a lower layer of the common electrode 24. In the configuration of the common electrode 24 shown in FIG. 22, since the common electrode 24 is cut in the horizontal direction so that a plurality of detection electrodes 12 are formed, a continuous opening 43 is provided only in a portion of the common electrode 24 to be cut, and corresponds to the adjacent pixel electrodes 19 in the horizontal direction.

Therefore, the common electrode 24, which is formed as a so-called solid pattern, can be divided at a desired position into a plurality of electrodes extending in the horizontal direction. Thus, the common electrode 24 also can be used as the detection electrodes 12.

FIG. 23 is a partially enlarged plan view showing a second example of the configuration of the common electrode 24.

In FIG. 23, a region 41 of the common electrode 24 corresponds to one sub-pixel. As shown in FIG. 23, continuous openings 43 extending in the horizontal direction are formed in the portions of the common electrode 24 other than those facing or overlapping the pixel electrodes 19 in the thickness direction of the liquid crystal display panel (i.e., the upper portions of the respective regions 41 in FIG. 23). The continuous openings 43 include the portions in which vias for connecting the pixel electrodes 19 and the TFTs are to be formed. With this configuration, the common electrode 24 can be formed into a plurality of strip-shaped electrodes extending in the horizontal direction without impairing its function. Moreover, the stripe-shaped electrodes can be classified into a predetermined number of groups by using a connection terminal or the like appropriately. Then, each group of strip-shaped electrodes is connected to the terminal extraction portion 17a shown in FIG. 6. Thus, the detection electrodes 12 that have a predetermined electrode width and extend in the horizontal direction can be provided, as shown in FIG. 6.

As described above, in the liquid crystal display device including the input device of the present technology, the detection electrodes 12 are arranged parallel to the scanning signal lines 10 of the liquid crystal display panel 1, and the driving electrodes 11 are arranged so as to cross the detection electrodes 12. The touch position can be detected by applying a driving signal to the driving electrodes 11 and detecting a detection signal output from each of the detection electrodes 12 during the touch detection period.

During the touch detection period, a detection operation is not performed in the detection electrode 12 in close proximity to the scanning signal line 10 to which the scanning signal is being applied, and a detection operation is performed in the detection electrodes 12 in close proximity to the scanning signal lines 10 to which the scanning signal is not being applied.

In the input device of the present technology, the detection electrodes are arranged parallel to the scanning signal lines so as to correspond to the respective line blocks of the scanning signal lines. The detection operation is performed by selecting a plurality of detection electrodes corresponding to the line blocks in which no scanning signal is being applied to the scanning signal lines. When the detection operation of the touch sensor is performed at the same time as the operation of updating the display of the liquid crystal display panel, a video signal is applied to the video signal lines of the display panel so that the voltage of the pixel electrodes is increased or decreased. According to the increase or decrease in the voltage of the pixel electrodes or a change in the potential of the video signal lines themselves, charge is transferred by capacitive coupling between the pixel electrodes or the video signal lines and the detection electrode, and this charge transfer may become noise of the detection signal. However, the input device having the above configuration effectively can prevent the detection of noise in the detection electrode. Therefore, a malfunction of the touch sensor can be eliminated and the sensitivity of the touch sensor can be improved. Consequently, the touch position can be detected with high accuracy.

As described above, when the touch sensor performs a detection operation so that a detection signal is not output from the detection electrode corresponding to the line block to which a scanning signal is being applied, the detection operation is not performed in the detection electrode 12-1 during the scanning period of the line block 10-1. Therefore, even if the user's finger touches a portion that corresponds to the detection electrode 12-1, the touch position cannot be detected. However, the detection operation is performed in the detection electrode 12-1 during the scanning period of the line blocks 10-2, 10-3, . . . , 10-N. For example, when the touch position is notified once a frame (e.g., once every 60 Hz) in the image display on the display panel, in view of the ratio of the scanning period of one line block to one frame period, the touch position can be recognized substantially sufficiently in the entire area of the image display screen.

In the input device of the present technology, the timing of the notification of the touch position information is not limited to one time per frame (e.g., 60 Hz). For example, the timing of the notification of the touch position information may be set appropriately by calculating the contact position during one frame period of the image display on the display panel using the output circuit of the signal detection circuit 7, in which the detection signals output from the detection electrodes are subjected to the arithmetic processing by the arithmetic element (MPU) 33 or the like, and then the result of the arithmetic processing is output to the outside as the touch position information, as shown in FIGS. 20 and 21. Consequently, the contact position during one frame period can be notified at any desired timing. For example, it is easy to set the timing so that the touch position information is calculated and notified to the outside when one-half of the N line blocks (i.e., the line blocks 10-1, 10-2, . . . , 10-N/2), corresponding to one-half of the entire area, have been scanned. In this case, the touch position information can be notified to the outside once per 0.5 frame, i.e., twice per frame of the image display on the display panel. If the frame frequency is, e.g., 60 Hz, the touch position information can be notified to the outside at 120 Hz.

In the input device of the present technology, it is not essential to perform a detection operation so that a touch position detection signal is not output from the detection electrode corresponding to the line block to which a scanning signal is being applied during the period of application of the scanning signal.

For example, the touch position can be detected with sufficient accuracy for practical use even by outputting the detection signal from the detection electrode corresponding to the line block to which the scanning signal is being applied in any of the following cases: (i) where noise added to the detection signal is removed, e.g., by using the configuration in which the differences between each of the detection signals of the adjacent detection electrodes are determined and then amplified, as shown in FIG. 21; (ii) where the influence of noise can be eliminated by performing appropriate arithmetic processing on the touch position detection signal output from each of the detection electrodes; and (iii) where the influence of noise due to the application of a scanning signal can be minimized, e.g., by the electrode arrangement of the input device in the display panel.

As described in the above embodiment, when the driving electrodes 11 are located outside of the liquid crystal display panel, parasitic capacitance between the driving electrodes 11 and the electrodes other than the detection electrodes arranged inside the liquid crystal display panel for image display can be suppressed. Therefore, power consumption of a pulse voltage applied to the driving electrodes can be reduced. Moreover, it is possible to increase the number of times the pulse voltage is applied while the power consumption is unchanged, or to set the potential difference of the pulse voltage to a high value. This can improve the touch position detection sensitivity of the touch sensor.

In order to allow the detection operation not to be performed selectively in the detection electrodes 12, e.g., the detection electrode 12 in which a detection operation is not to be performed may be separated from the signal detection circuit by using a switch, and this detection electrode 12 may be connected to a predetermined potential. Alternatively, when the analog data is converted into digital data, and then subjected to arithmetic processing by the MPU or the like, the arithmetic processing may be performed without using the digital data that has been accumulated during the period in which a detection operation is not performed.

In the above embodiment, the IPS type liquid crystal display panel is used in the liquid crystal display device. However, the display panel used in the liquid crystal display device is not limited to the IPS type, and a known drive type liquid crystal display panel such as a so-called vertically oriented type also can be used. In this case, although particularly the common electrode may be formed on the counter substrate rather than the TFT substrate, various configurations can be employed. For example, as described in the above embodiment, the electrodes may be arranged appropriately in the boundary area that surrounds each of the effective areas and does not contribute to image display, and those electrodes may be used as the driving electrodes or the detection electrodes of the input device.

### INDUSTRIAL APPLICABILITY

As described above, the present technology is the invention useful in a projected capacitive type input device and a liquid crystal display device using the input device.

1. An input device provided in a display device that updates a display by sequentially applying a scanning signal to a plurality of scanning signal lines during one frame period,
the input device comprising:
a plurality of driving electrodes and a plurality of detection electrodes that are arranged so as to cross each other; and
capacitive elements that are formed between the driving electrodes and the detection electrodes.
wherein the detection electrodes are arranged parallel to the scanning signal lines of the display device, and
a touch position is detected by applying a driving signal to the driving electrodes and detecting a detection signal output from each of the detection electrodes during a touch detection period.

2. The input device according to claim 1, wherein during the touch detection period, a detection operation is not performed in the detection electrode in close proximity to the scanning signal line to which the scanning signal is being applied, and a detection operation is performed in the detection electrodes in close proximity to the scanning signal lines to which the scanning signal is not being applied.

3. An input device provided in a display device that includes a plurality of scanning signal lines that are grouped into N line blocks, each line block having M scanning signal lines, and that updates a display by sequentially applying a scanning signal to the scanning signal lines during one frame period,
the input device comprising:
a plurality of driving electrodes and a plurality of detection electrodes that are arranged so as to cross each other; and
capacitive elements that are formed between the driving electrodes and the detection electrodes,
wherein the detection electrodes are arranged parallel to the scanning signal lines of the display device so as to correspond to the respective N line blocks of the scanning signal lines, and
a touch position is detected by applying a driving signal to the driving electrodes and detecting a detection signal output from each of the detection electrodes during a touch detection period.

4. The input device according to claim 3, wherein during the touch detection period, a detection operation is not performed in the detection electrode corresponding to the line block of the scanning signal lines to which the scanning signal is being applied, and a detection operation is performed in the detection electrodes corresponding to the line blocks of the scanning signal lines to which the scanning signal is not being applied.

5. The input device according to claim 1, wherein at least one of the plurality of detection electrodes and the plurality of driving electrodes is located inside the display device so as to be parallel to the scanning signal lines or to cross the scanning signal lines.

6. A liquid crystal display device comprising:
a liquid crystal display panel that includes a plurality of pixel electrodes and a common electrode provided so as to be opposed to the pixel electrodes, and updates a display by sequentially applying a scanning signal to switching elements for controlling an application of a voltage to the pixel electrodes; and
an input device that includes a plurality of driving electrodes and a plurality of detection electrodes that are arranged so as to cross each other, and capacitive elements that are formed between the driving electrodes and the detection electrodes,
wherein at least one of the plurality of driving electrodes and the plurality of detection electrodes is located inside the liquid crystal display panel,
the detection electrodes are arranged parallel to scanning signal lines of the liquid crystal display panel, and the driving electrodes are arranged so as to cross the detection electrodes, and
a touch position is detected by applying a driving signal to the driving electrodes and detecting a detection signal output from each of the detection electrodes during a touch detection period.

7. The liquid crystal display device according to claim 6, wherein during the touch detection period, a detection operation is not performed in the detection electrode in close proximity to the scanning signal line to which the scanning signal is being applied, and a detection operation is performed in the detection electrodes in close proximity to the scanning signal lines to which the scanning signal is not being applied.
